(19) United States
(12) Patent Application Publication
(10) Pub. No.: US 2006/0088157 A1
(43) Pub. Date: Apr. 27, 2006

(54) Public key encryption apparatus

(76) Inventor: Mikio Fujii, Kawasaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/254,719

(22) Filed: Oct. 21, 2005

(30) Foreign Application Priority Data
Oct. 22, 2004 (JP) 2004-308655

(51) Int. Cl. H04L 9/30

(52) U.S. Cl. 380/30

(57) ABSTRACT

According to an aspect of this invention, there is provided a public key encryption apparatus comprising a device generating a single photon, a device generating a random number, a storage device storing the random number as a private key, a device which transmits a single photon encoded by the private key composed of a basis set identifying value section and a bit value section, a device receiving the single photon, a device creating message information and an authenticator, a device encrypting the quantum state of the received single photon on the basis of the message information and authenticator and transmitting the single photon, a device decrypting the message information and authenticator from the received single photon according to the private key, and a device which invalidates the message information if the authenticator calculated from the decrypted message information is inconsistent with the decrypted authenticator.

### CROSS-REFERENCE TO RELATED APPLICATIONS

This application is based upon and claims the benefit of priority from prior Japanese Patent Application No. 2004-308655, filed Oct. 22, 2004, the entire contents of which are incorporated herein by reference.

### BACKGROUND OF THE INVENTION

This invention relates to a public key encryption apparatus capable of realizing a public key encryption method which can assure security on the basis of the uncertainty principle, is safe from quantum-computer-based attacks, and can be practiced in the present state of the art.

In the public key encryption method, a key used in encryption differs from a key used in decryption. Such a public key encryption method was devised by Diffie and Hellman in 1976 (refer to W. Diffie and M. Hellman, “New directions in cryptography,” IEEE Trans. Inf. Theory, IT-22(6), 1976, pp. 644-654). In the public key encryption method, an encryption key is opened to the public and a decryption key is concealed. This makes such secret communications as described in the following items (i) and (ii) in the public key encryption method: (i) any person who has an encryption key opened to the public (hereinafter, also referred to as a public key) can create an encrypted text; and (ii) only a person who has a concealed decryption key can obtain a plain text from the encrypted text. In the public key encryption method, however, it has to be very difficult to obtain the decryption key from the encryption key.

In the symmetric-key encryption method, the encryption key and the decryption key are the same. For this reason, the symmetric-key encryption method requires a safe communication channel for key distribution. In contrast, the public key encryption method requires no safe communication channel for key distribution, as long as there is a valid public key. This is a distinctive characteristic of the public key encryption method.

This type of public key encryption method is generally configured using a mathematical problem expected to have calculation amount difficulty. Here, “calculation amount difficulty” means difficulty in solving a problem because the amount of calculations to be done is enormous. Accordingly, the public key encryption method bases security on the calculation amount difficulty of the mathematical problem used.

However, the expectation that there is calculation amount difficulty has not been proved definitely, but is an assumption. For this reason, the expectation that there is calculation amount difficulty might be disproved by the discovery of a new algorithm. A “prime factorization problem” and a “discrete logarithm problem” for which calculation amount difficulty had been believed for a long time have been proved to be easily solvable in polynomial time with a quantum computer using the Shor algorithm in 1994 (refer to P. W. Shor, “Algorithms for quantum computation: discrete logarithms and factoring,” In Proceedings of the 35^{th} Annual Symposium on Foundations of Computer Science, IEEE Computer Society, Los Alamitos, Calif., 1994, pp. 124-134).

Accordingly, if a quantum computer has been completed, the grounds for security based on the calculation amount difficulty of a “prime factorization problem” or a “discrete logarithm problem” will collapse in the mainstream public key encryption. The main public key encryption includes RSA encryption, Rabin encryption, ElGamal encryption, and elliptic curve cryptosystem.

In this connection, a new public key encryption method has been investigated which uses a problem expected to have calculation amount difficulty other than a “prime factorization problem” or a “discrete logarithm problem” as the grounds for security. However, even if a new public key encryption method has been obtained, the grounds for security might collapse, unless calculation amount difficulty has been proved definitely. Therefore, even if a new public key encryption has been obtained, this hasn't basically guaranteed its security.

Meanwhile, quantum cryptography has been known to guarantee its security on the basis of the uncertainty principle, the basic principle of the quantum theory, instead of a certain mathematical problem. The quantum cryptography was devised by Bennett and Brassard in 1984 by developing Wiesner's idea in about 1969 (refer to C. H. Bennett and G. Brassard, “Quantum cryptography: Public key distribution and coin tossing,” in Proceedings of the IEEE International Conference on Computers, Systems, and Signal Processing, Bangalore, India, IEEE, New York, 1984, pp. 175-179).

Quantum cryptography is precisely referred to as quantum key distribution system. Quantum cryptography uses the fact that, if an eavesdropper makes measurements without using the proper basis set, the measured quantum state will change. Quantum cryptography is a method of enabling the sender and the recipient to share a random number key, while monitoring the presence or absence of eavesdropping, depending on the presence or absence of a change in the quantum state. It has been proved that quantum cryptography is safe even from quantum-computer-based attacks unless the system of the quantum theory including the uncertainty principle collapses.

The uncertainty principle has been verified and established in terms of both of theories and experiments for about 80 years. Therefore, it is generally accepted that the uncertainty principle is much more robust as the grounds for security than mathematically unproven assumptions.

However, the aforementioned quantum cryptography is limited in function to key distribution and falls short of the realization of a public key encryption method practicable in the present state of the art.

### BRIEF SUMMARY OF THE INVENTION

It is an object of the present invention to provide a public key encryption apparatus capable of realizing a public key encryption method which can guarantee security on the basis of the uncertainty principle, is safe from quantum-computer-based attacks, and can be practiced in the present state of the art.

According to a first aspect of the present invention, there is provided a public key encryption apparatus comprising: a device configured to generate a single photon; a random number generating device configured to generate a random number; a storage device configured to store the generated random number as a private key; a device configured to divide the random number of the private key into a basis set identifying value section and a bit value section to allocate quantum states, and encode the random number of the private key as a quantum state of the single photon; a device configured to transmit the encoded single photon; a device configured to receive the transmitted single photon; a device configured to generate message information to be transmitted and an authenticator depending on the message information; a device configured to encrypt the message information and authenticator into a quantum state of the single photon by bit-inverting the quantum state of the received single photon; a device configured to transmit the encrypted single photon; a device configured to receive the transmitted single photon; a device configured to measure the received single photon on the basis of the private key in the storage device and decrypt the encrypted message information and authenticator according to the result of the measurement; a device configured to calculate an authenticator from the decrypted message information, compare the calculated authenticator with the encrypted authenticator, and determine whether they coincide with each other; and a device configured to invalidate the encrypted message information if the result of the measurement has shown that they do not coincide with each other.

According to a second aspect of the present invention, there is provided a public key encryption apparatus comprising: a single photon generator which generates single photons sequentially; a random number generator which generates a random number; a storage medium in which the generated random number is stored; a first phase modulator which encodes a quantum state by changing the phase of the single photon according to the random number in the storage medium; a second phase modulator which bit-inverts the encoded single photon, while maintaining the basis set of the quantum state, by changing the phase of the encoded single photon, and which encodes message information and an authenticator as the result of the bit-inversion; a third phase modulator which, according to the random number in the storage medium, changes the phase of the single photon encoded by the second phase modulator; and a device which is configured to have a photon detector on each of the transmission optical axis and reflection optical axis of a beam splitter and detect the phase of the single photon obtained by the third phase modulator.

According to a third aspect of the present invention, there is provided a public key encryption apparatus comprising: a single photon generator which generates single photons sequentially; a random number generator which generates a random number; a storage medium in which the generated random number is stored; a first polarizer which encodes a quantum state by changing the polarization component of the single photon according to the random numbers in the storage medium; a second polarizer which bit-inverts the encoded single photon, while maintaining the basis set of the quantum state, by changing the polarization component of the encoded single photon, and which encodes message information and an authenticator as the result of the bit-inversion; a third polarizer which, according to the random number in the storage medium, changes the polarization component of the single photon encoded by the second polarizer; and a device which is configured to have a photon detector on each of the transmission optical axis and reflection optical axis of a polarizing beam splitter and detect the polarization component obtained by the third polarizer.

According to a fourth aspect of the present invention, there is provided a public key encryption apparatus comprising: a device configured to store a private key as classic information (x, k); a device configured to encode the stored classic information (x, k) into a quantum state and output a public key as quantum information |x>ₖ, the result of encoding; a device configured to encode previously stored message information and an authenticator which depends on the message and whose bit position relationship is unobvious into a quantum state of the public key when receiving the public key and output an encrypted text, the result of encoding; a device configured to measure the quantum state of the encrypted text on the basis of the public key k when receiving the encrypted text and decrypt the encrypted text, the result of the measurement; a device configured to verify the consistency between the message information and authenticator obtained through the decryption; and a device configured to detect the interception or falsification of the public key or the encrypted text when the consistency has not been verified.

According to a fifth aspect of the present invention, there is provided a public key encryption apparatus comprising: a quantum information creating device configured to perform the process (b, k) [symbol] ||b>ₖ of creating quantum information |b>ₖ from classic information (b, k) composed of the basis set identifying information k and bit value b, where basis set identifying information on a quantum state is k and a bit value in the basis set identified by the basis set identifying information is b; and a quantum information output device configured to output the quantum information |b>ₖ, wherein the output quantum information |b>ₖ is guaranteed to be safe from interception or falsification on the basis of the creating process being equivalent to one-way function mapping with trapdoor information k and of the uncertainty principle in the quantum theory.

According to a sixth aspect of the present invention, there is provided a public key encryption apparatus comprising a recipient apparatus and a sender apparatus, the recipient apparatus including a public key storage device configured to store a public key composed of basis set identifying random number information and phase modulation random number information, a photon generating device configured to generate single photons sequentially, a photon dividing device configured to divide the single photon into two quantum states and output a first quantum state and a second quantum state, the result of the division, a first phase modulation device configured to change the phase of the first quantum state on the basis of the private key in the private key storage device and output a public key quantum state, the result of changing the phase, toward the sender apparatus, a second phase modulation device configured to change the phase of an encrypted text quantum state on the basis of the private key in the private key storage device so as to offset a variation in the phase caused by the first phase modulation device from the encrypted text quantum state, when receiving from the sender apparatus the encrypted text quantum state obtained by inverting the phase of the public key quantum state according to each bit in message information and an authenticator, and obtain a plain text quantum state, the result of the changing the phase, a photon phase detecting device configured to detect the phase of a single photon from the plain text quantum state and the second quantum state and obtain each bit according to the result of the detection, a detection result storage device configured to store the message information and authenticator composed of each bit, a verifying device configured to verify whether the message information and authenticator in the detection result storage device are consistent with each other, and a message invalidating device configured to invalidate the message information in the detection result storage device if the result of the verification has shown that the message information and authenticator are inconsistent with each other, and the sender apparatus including a message storage device configured to store message information, an authenticator processing device configured to generate an authenticator from the message information in the message storage device and concatenate the authenticator with the message information, and a third phase modulation device configured to invert the phase of the public key quantum state, while maintaining the basis set of the public key quantum state output from the recipient apparatus, on the basis of each bit in the concatenated message information and authenticator, and output the encrypted text quantum state, the result of inverting the phase, toward the recipient apparatus.

According to a seventh aspect of the present invention, there is provided a public key encryption apparatus comprising a recipient apparatus and a sender apparatus, the recipient apparatus including a public key storage device configured to store a public key composed of basis set identifying random number information and phase modulation random number information, a photon generating device configured to generate single photons sequentially, a phase modulation device configured to change the phase of the single photon on the basis of the private key in the private key storage device and output a public key single photon, the result of changing the phase, a photon dividing device configured to divide the public key single photon into two quantum states and output a first public key quantum state and a second public key quantum state, the result of the division, a photon phase detecting device configured to detect the phase of a single photon from the encrypted text quantum state and the second public key quantum state when receiving from the encrypted test state obtained by inverting the phase of the first public key quantum state according to each bit in message information and an authenticator, and obtain each bit according to the result of the detection, a detection result storage device configured to store the message information and authenticator composed of each bit, a verifying device configured to verify whether the message information and authenticator in the detection result storage device are consistent with each other, and a message invalidating device configured to invalidate the message information in the detection result storage device if the result of the verification has shown that the message information and authenticator are inconsistent with each other, and the sender apparatus including a message storage device configured to store message information, an authenticator processing device configured to generate an authenticator from the message information in the message storage device and concatenate the authenticator with the message information, and a third phase modulation device configured to invert the phase of the first public key quantum state, while maintaining the basis set of the first public key quantum state output from the recipient apparatus, on the basis of each bit in the concatenated message information and authenticator, and output the encrypted text quantum state, the result of inverting the phase, toward the recipient apparatus.

According to an eighth aspect of the present invention, there is provided a public key encryption apparatus comprising a recipient apparatus and a sender apparatus, the recipient apparatus including a public key storage device configured to store a public key composed of basis set identifying random number information and random number polarization information, a photon generating device configured to generate single photons sequentially, a first polarizing device configured to change the polarization component of the single photon on the basis of the private key in the private key storage device and output a public key quantum state, the result of the changing, toward the sender apparatus, a second polarizing device configured to change the polarization component of the encrypted text quantum state on the basis of the private key in the private key storage device so as to offset a variation in the polarization component caused by the first polarizing device from the encrypted text quantum state, when receiving from the sender apparatus the encrypted text quantum state obtained by rotating the polarization component of the public key quantum state by n/2 radians according to each bit in message information and an authenticator, and obtain a plain text quantum state, the result of the changing, a photon phase detecting device configured to detect the polarization component of a single photon from the plain text quantum state and obtain each bit according to the result of the detection, a detection result storage device configured to store the message information and authenticator composed of each bit, a verifying device configured to verify whether the message information and authenticator in the detection result storage device are consistent with each other, and a message invalidating device configured to invalidate the message information in the detection result storage device if the result of the verification has shown that the message information and authenticator are inconsistent with each other, and the sender apparatus including a message storage device configured to store message information, an authenticator processing device configured to generate an authenticator from the message information in the message storage device and concatenate the authenticator with the message information, and a third polarizing device configured to rotate the polarization component of the public key quantum state by n/2 radians, while maintaining the basis set of the public key quantum state output from the recipient apparatus, on the basis of each bit in the concatenated message information and authenticator, and output an encrypted text quantum state, the result of the rotation, toward the recipient apparatus.

According to a ninth aspect of the present invention, there is provided a public key encryption apparatus comprising a recipient apparatus, a sender apparatus, and a Faraday mirror, the recipient apparatus including a public key storage device configured to store a public key composed of basis set identifying random number information and phase modulation random number information, a photon generating device configured to generate single photons sequentially, a photon dividing device configured to divide the single photon into two quantum states and output a first quantum state and a second quantum state, the result of the division, a first phase modulation device having the function of changing the phase of the first quantum state on the basis of the private key in the private key storage device and outputting a first public key quantum state, the result of changing the phase, toward the sender apparatus and the function of changing the phase of an input second encrypted text quantum state on the basis of the private key in the private key storage device so as to offset a variation in the phase caused by the private key from the second encrypted text quantum state and outputting a second plain text quantum state, the result of changing the phase, a polarizing beam splitter having the function of causing the output first public key quantum state to pass through toward the sender apparatus, the function of receiving the first public key quantum state obtained by rotating the polarization component of the first public key quantum state through n/2 radians by the Faraday mirror and then reflecting the first public key quantum state, the function of reflecting an input second public key quantum state toward the sender apparatus, and the function of receiving from the sender apparatus a second encrypted text quantum state obtained by rotating the polarization component of the second public key quantum state through n/2 radians by the Faraday mirror and inverting the phase of the second public key quantum state according to each bit in message information and an authenticator and of causing the second encrypted text quantum state to pass through toward the first phase modulation device, a polarization rotating device having the function of rotating the polarization component of the first public key quantum state reflected by the polarizing beam splitter by n/2 radians and outputting the result and the function of rotating the polarization component of the input second public key quantum state by n/2 radians and outputting the result toward the polarizing beam splitter, a second phase modulation device having the function of changing the phase of the first public key quantum state on the basis of the private key in the private key storage device so as to offset a variation in the phase caused by the first phase modulation device from the first public key quantum state output from the polarization rotating device and outputting a first quantum state, the result of changing the phase, and the function of changing the phase of the second quantum state on the basis of the private key in the private key storage device and outputting a second public key quantum state, the result of changing the phase, to the polarization rotating device, a photon phase detecting device configured to detect the phase of a single photon from the first quantum state and the second plain text quantum state output from the respective phase modulation devices and obtain each bit according to the result of the detection, a detection result storage device configured to store the message information and authenticator composed of each bit, a verifying device configured to verify whether the message information and authenticator in the detection result storage device are consistent with each other, and a message invalidating device configured to invalidate the message information in the detection result storage device if the result of the verification has shown that the message information and authenticator are inconsistent with each other, and the sender apparatus including a message storage device configured to store message information, an authenticator processing device configured to generate an authenticator from the message information in the message storage device and concatenate the authenticator with the message information, and a third phase modulation device configured to invert the phase of the second public key quantum state, while maintaining the basis set of the second public key quantum state, on the basis of each bit in the concatenated message information and authenticator, when receiving the second public key quantum state which is output from the recipient apparatus and whose polarization component is rotated through n/2 radians by the Faraday mirror, and output a second encrypted text quantum state, the result of inverting the phase, toward the recipient apparatus.

According to a tenth aspect of the present invention, there is provided a public key encryption apparatus comprising a recipient apparatus, a sender apparatus, and a Faraday mirror, the recipient apparatus including a public key storage device configured to store a public key composed of basis set identifying random number information and phase modulation random number information, a photon generating device configured to generate single photons sequentially, a photon dividing device configured to divide the single photon into two quantum states and output a first quantum state and a second quantum state, the result of the division, a polarizing beam splitter having the function of causing the output first quantum state to pass through toward the sender apparatus, the function of receiving the first quantum state obtained by rotating the polarization component of the first quantum state through n/2 radians by the Faraday mirror and then reflecting the first quantum state, the function of reflecting an input second public key quantum state toward the sender apparatus, and the function of receiving from the sender apparatus a second encrypted text quantum state obtained by rotating the polarization component of the second public key quantum state through n/2 radians by the Faraday mirror and inverting the phase of the second public key quantum state according to each bit in message information and an authenticator and of causing the second encrypted text quantum state to pass through, a polarization rotating device having the function of rotating the polarization component of the first quantum state reflected by the polarizing beam splitter by n/2 radians and outputting the result and the function of rotating the polarization component of the input second public key quantum state by n/2 radians and outputting the result toward the polarizing beam splitter, a phase modulation device having the function of changing the phase of the first quantum state output from the polarization rotating device on the basis of the private key in the private key storage device and outputting a first public key quantum state, the result of changing the phase, and the function of changing the phase of the second quantum state on the basis of the private key in the private key storage device and outputting a second public key quantum state, the result of changing the phase, to the polarization rotating device, a photon phase detecting device configured to detect the phase of a single photon from the first public key quantum state and the second encrypted text quantum state and obtain each bit according to the result of the detection, a detection result storage device configured to store the message information and authenticator composed of each bit, a verifying device configured to verify whether the message information and authenticator in the detection result storage device are consistent with each other, and a message invalidating device configured to invalidate the message information in the detection result storage device if the result of the verification has shown that the message information and authenticator are inconsistent with each other, and the sender apparatus including a message storage device configured to store message information, an authenticator processing device configured to generate an authenticator from the message information in the message storage device and concatenate the authenticator with the message information, and a third phase modulation device having the function of inverting the phase of the first quantum state, while maintaining the basis set of the first quantum state output from the recipient apparatus, on the basis of each bit in the concatenated message information and authenticator and outputting a first plain text quantum state, the result of inverting the phase, and the function of inverting the phase of the second public key quantum state, while maintaining the basis set of the second public key quantum state output from the recipient apparatus, on the basis of each bit in the concatenated message information and authenticator, and outputting a second encrypted text quantum state, the result of inverting the phase, toward the recipient apparatus.

In the first to fourth aspects and the sixth to tenth aspects of the invention, the public key obtained by encoding the quantum state of a single photon on the basis of the private key is output. Then, the encrypted text obtained by encrypting the public key on the basis of message information and an authenticator is received. Thereafter, the encrypted text is decrypted using the private key. Message information and an authenticator are obtained as the result of the decryption. That is, the first to fourth aspects and sixth to tenth aspects of the invention have such a configuration as uses in communication the public key obtained by encoding the quantum state of a single photon and the encrypted text obtained by encrypting the public key. Therefore, if the public key or encrypted text during compunction has been intercepted or falsified, the quantum state is destroyed and therefore the verification of the authenticator enables interception and the like to be detected. At this time, if the intercepted quantum state is copied accurately, detection is prevented. However, to make an accurate copy, it is necessary to know the quantum state accurately. Here, to know the quantum state accurately, a measurement system in the same basis set as that of the public key is required. However, the basis set of the public key has been changed using a random number. Therefore, since an eavesdropper cannot know the quantum state accurately, he or she cannot make an accurate copy of the quantum state. Consequently, the eavesdropper cannot prevent the interception from being detected. Moreover, if a measurement system in a basis set differing from that of the public key is used, it is impossible in terms of probability to obtain the correct measurements over all of the bits, since the quantum state is randomized and measured under the uncertainty principle.

Therefore, it is possible to realize public key encryption method which can guarantee security on the basis of the uncertainty principle, is safe from quantum-computer-based attacks, and can be realized in the present state of the art.

Furthermore, the fifth aspect of the invention is so configured that, in a case where quantum information is created according to the basis set identifying information k and bit value b, the bit value b is obtained when the quantum information is decrypted using trapdoor information k.

Therefore, since the interception of the quantum state is impossible in terms of probability as described above, it is possible to realize public key encryption method which can ensure security on the basis of the uncertainty principle, is safe from quantum-computer-based attacks, and further can be practiced in the present state of the art.

### BRIEF DESCRIPTION OF THE SEVERAL VIEWS OF THE DRAWING

FIG. 1 is a schematic diagram showing the configuration of a public key encryption apparatus according to a first embodiment of the present invention;

FIG. 2 is a flowchart to help explain the operation of the first embodiment;

FIG. 3 shows the relationship between a private key and a phase delay in the first embodiment;

FIG. 4 shows the relationship between the bit value of concatenated data and a phase delay in the first embodiment;

FIG. 5 shows the relationship between a private key and a phase delay in the first embodiment;

FIG. 6 is a schematic diagram showing the configuration of a public key encryption apparatus according to a second embodiment of the present invention;

FIG. 7 shows the relationship between a private key and a phase delay in the second embodiment;

FIG. 8 shows the relationship between the bit value of concatenated data and a phase delay in the second embodiment;

FIG. 9 is a schematic diagram showing the configuration of a public key encryption apparatus according to a third embodiment of the present invention;

FIG. 10 is a diagram to help explain the direction of linearly polarized light in the third embodiment;

FIG. 11 shows the relationship between a private key and the rotation angle of the polarization component in the third embodiment;

FIG. 12 shows the relationship between the bit value of concatenated data and the rotation angle of the polarization component in the third embodiment;

FIG. 13 shows the relationship between a private key and the rotation angle of the polarization component in the third embodiment;

FIG. 14 is a schematic diagram showing the configuration of a public key encryption apparatus according to a fourth embodiment of the present invention;

FIG. 15 is a diagram to help explain the operation of the fourth embodiment;

FIG. 16 shows the relationship between a private key and a phase delay in the fourth embodiment;

FIG. 17 shows the relationship between a private key and a phase delay in the fourth embodiment;

FIG. 18 shows the relationship between a private key and a phase delay in the fourth embodiment;

FIG. 19 shows the relationship between the bit value of concatenated data and a phase delay in the fourth embodiment;

FIG. 20 shows the relationship between a private key and a phase delay in the fourth embodiment;

FIG. 21 is a schematic diagram showing the configuration of a public key encryption apparatus according to a fifth embodiment of the present invention;

FIG. 22 is a diagram to help explain the operation of the fifth embodiment;

FIG. 23 shows the relationship between a private key and a phase delay in the fifth embodiment;

FIG. 24 shows the relationship between a private key and a phase delay in the fifth embodiment;

FIG. 25 shows the relationship between the bit value of concatenated data and a phase delay in the fifth embodiment;

FIG. 26 is a schematic diagram showing the configuration of a modification of the first embodiment;

FIG. 27 is a schematic diagram showing the configuration of a modification of the second embodiment;

FIG. 28 is a schematic diagram showing the configuration of a modification of the third embodiment;

FIG. 29 is a schematic diagram showing the configuration of a modification of the fourth embodiment; and

FIG. 30 is a schematic diagram showing the configuration of a modification of the fifth embodiment.

### DETAILED DESCRIPTION OF THE INVENTION

Hereinafter, referring to the accompanying drawings, embodiments of the present invention will be explained. Before that, the outline of this invention will be described. Let basis set identifying information on a quantum state be k. Let a bit value in the basis set identified by the basis set identifying information k be b. At this time, the process (b, k) [symbol] |b>ₖ of creating quantum information |b>ₖ from classic information (b, k) composed of the basis set identifying information k and the bit value b is equivalent to a one-way function mapping with trapdoor information k. On the basis of the creating process being equivalent to the mapping and the uncertainty principle, the basic principle of the quantum theory, the present invention guarantees quantum information |b>ₖ to be safe from eavesdropping or falsification.

Specifically, the recipient apparatus memorizes a private key as classic information (x, k) and encodes the classic information (x, k) into a quantum state. The recipient apparatus outputs a public key as encoded quantum information |x>ₖ. As this type of encoding, for example, a phase delay of photon or the rotation of polarized components may be used.

Receiving the public key, the sender apparatus encodes previously stored message information and an authenticator which depends on the message information and for which the relationship between bit positions is unobvious into a quantum state of the public key. The sender apparatus outputs an encrypted text, the result of encoding.

Receiving the encrypted text, the recipient apparatus measures the quantum state of the encrypted text on the basis of the private key k and decrypts the encrypted text as the result of the measurement. The recipient apparatus verifies the consistency between the decrypted message information and the authenticator. When there is no consistency between them, the recipient apparatus detect the eavesdropping or falsification of the public key or encrypted text.

What has been described above is the outline of this invention. Hereinafter, embodiments of the present invention will be explained concretely.

### FIRST EMBODIMENT

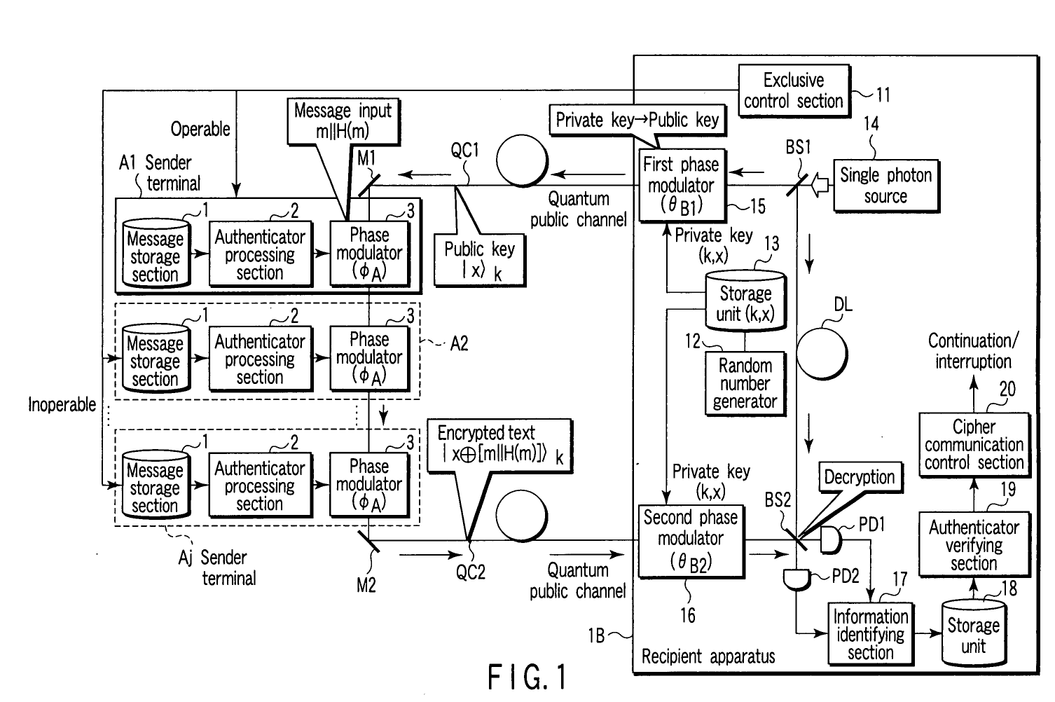

FIG. 1 is a schematic diagram showing the configuration of a public key encryption apparatus according to a first embodiment of the present invention. In the public key encryption apparatus, a j number of sender terminals A1 to Aj and a single recipient apparatus 1B are connected to one another via quantum public channels QC1, QC2.

Each of the sender terminals A1 to Aj has a message storage section 1, an authenticator processing section 2, and a phase modulator 3.

The message storage section 1 stores message information.

The authenticator processing section 2 has the function of creating an authenticator from the message information in the message storage section 1 and concatenating the authenticator to the message information.

The phase modulator (a third phase modulation device) 3 has the function of inverting the phase of the public key quantum state, while mainlining the basis set of the public key quantum state output from the recipient apparatus 1B on the basis of each bit in the message information and authenticator concatenated at the authenticator processing section 2. The phase modulator 3 also has the function of outputting the encrypted text quantum state, the result of inverting the phase, toward the recipient apparatus 1B.

The recipient apparatus 1B includes an exclusive control section 11, a random number generator 12, a storage unit 13, a single photon source 14, a first beam splitter BS1, a first phase modulator 15, a second phase modulator 16, a second beam splitter BS2, a first and a second photon detector PD1, PD2, an information identifying section 17, a storage unit 18, an authenticator verifying section 19, and a cipher communication control section 20.

The exclusive control section 11 has an exclusive control function. The exclusive control function is the function of bringing only the calling sender terminal A1 among a plurality of sender terminals A1 to Aj into the operable state and the other sender terminals A2 to Ai into the inoperable state.

The random number generator 12 has the function of generating two different random numbers k, x which have the same length and making the storage unit 13 hold the random numbers k, x as private keys k, x in secret. One random number k is a basis set identifying value k (or basis set identifying random number information). The other random number x is a bit value x (or phase modulation random number information). Each of the bit lengths of the random numbers k, x is larger than the bit length of the data obtained by concatenating the message information and authenticator explained later.

In the storage unit 13, the random numbers k, x written as private keys by the random number generator 12 are stored. From a security viewpoint, it is desirable that the private keys k, x should be discarded each time they are used in encryption and decryption. However, in a special case where some of security may be sacrificed to increase the processing speed, a used private key may be used again on the basis of, for example, a prepared private key table. That is, as a general rule, the private keys k, x are used once and then thrown away. However, by way of exception, they may be used again as long as security is maintained, depending on the use environment. The reusability of the private keys holds true for each of the embodiments explained below.

The single photon source 14 generates single photon pulses sequentially and outputs a single photon pulse to the first beam splitter BS1. A single photon pulse is a photon pulse including only one photon. Here, a photon is the smallest unit of optical energy which cannot be divided any further. Therefore, a single photon pulse cannot be divided any further even by a beam splitter or the like.

The first beam splitter (or photon dividing device) BS1 divides a single photon pulse into two quantum states, thereby obtaining a first quantum state and a second quantum state as the result of the division. The first quantum state is output from the first beam splitter BS1 to the first phase modulator 15. The second quantum state is output from the first beam splitter BS1 to a delay line DL. Some supplementary explanation will be given in connection with the definition of a single photon pulse. A single photon pulse itself cannot be divided. A single photon pulse is output in the form of two quantum states which correlate with each other.

On the basis of the private keys k, x in the storage unit 13, the first phase modulator 15 changes the phase of the first quantum state input from the first beam splitter BS1. The first phase modulator 15 outputs the public key quantum state, the result of changing the phase of the first quantum state, toward the sender terminal A1.

The second phase modulator 16 receives from the sender terminal A1 the encrypted text quantum state obtained by inverting the phase of the public key quantum state according to each bit in the message information and authenticator. The second phase modulator 16 changes the phase of the encrypted text quantum state on the basis of the private keys k, x in the storage unit 13 so as to offset a variation in the phase caused by the first phase modulator 15 from the encrypted text quantum state. The second phase modulator 16 outputs a plain text, the result of changing the phase of the encrypted text quantum state, to the second beam splitter BS2. Here, “offset” means returning a variation θ_{B1} in the phase caused by the first phase modulator 15 to the phase equivalent to that before the change. An example of offset is to change the phase by (2n−θ_{B1}) [rad] for every bit value x in the same basis set.

The second beam splitter BS2 mixes the plain text quantum state received from the second phase modulator 16 with the second quantum state passed through the delay line DL, producing two quantum states as the result of the mixing. Of the two, one quantum state is output from the second beam splitter BS2 to the first photon detector PD1. Of the two, the other quantum state is output from the second beam splitter BS2 to the second photon detector PD2.

The first photon detector PD1 is a light-receiving element, such as an avalanche photodiode. The first photon detector PD1 is provided on the transmission optical axis of the second phase modulator 16 and on the reflection optical axis of the delay line DL. The first photon detector PD1 has the function of sending a sense signal indicating bit “0” to the information identifying section 17, when detecting a single photon from the quantum state received from the second beam splitter BS2.

The second photon detector PD2 is a light-receiving element, such as an avalanche photodiode. The second photon detector PD2 is provided on the transmission optical axis of the delay line DL and on the reflection optical axis of the second phase modulator 16. The second photon detector PD2 has the function of sending a sense signal indicating bit “1” to the information identifying section 17, when detecting a single photon from the quantum state received from the second beam splitter BS2. The transmission optical axis of the second phase modulator 16 and the transmission optical axis of the delay line DL are at right angles to each other at the second beam splitter BS2.

Here, the second beam splitter BS2 and the first and second photon detectors PD1, PD2 detect the phase of a single photon from the plain text quantum state and the second quantum state and obtain each bit according to the result of the detection. That is, the second beam splitter BS2 and the first and second photon detectors PD1, PD2 constitute a photon phase detecting device.

The information identifying section 17 receives a sense signal indicating each bit from each of the photon detectors PD1, PD2. The information identifying section 17 identifies a bit train from the first bit to the N-th bit in each sense signal as message information m′ and a bit train from the (N+1)-th and later bits as an authenticator a. The information identifying section 17 has the function of writing the message information m′ and authenticator a into the storage unit 18.

The storage unit 18 stores the message information m′ and authenticator a written by the information identifying section.

The authenticator verifying section 19 has the function of verifying whether the message information m′ and authenticator a in the storage unit 18 are consistent with each other and sending the result of the verification to the cipher communication control section 20.

The cipher communication control section (or message invalidating device) 20 has the function of, when the result of the verification at the authenticator verifying section 19 has shown that they are inconsistent with each other, invalidating the message information in the storage unit 18 and interrupting subsequent cipher communication.

The quantum public channels QC1, QC2 are channels which are not always safe from eavesdropping or falsification. In the first embodiment, optical fiber is used for the quantum public channels QC1, QC2. However, the quantum public channels QC1, QC2 are not limited to optical fiber or the like and may be, for example, free space.

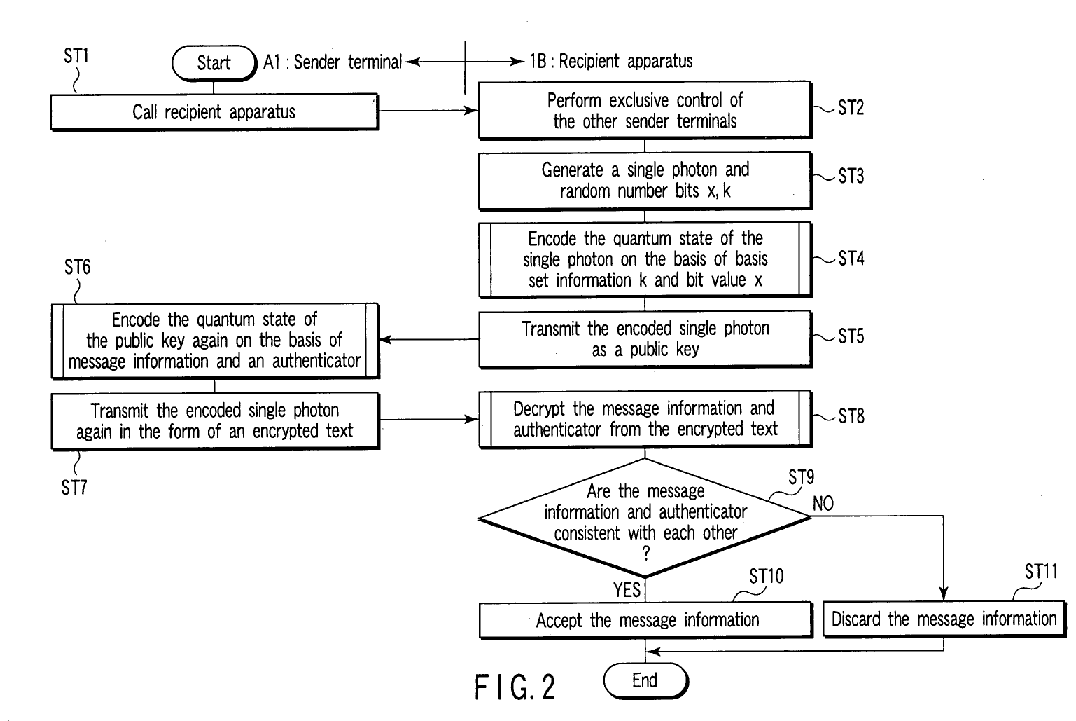

Next, the operation of the public key encryption apparatus configured described above will be explained using a flowchart in FIG. 2.

First, the sender terminal A1 transmits a communication start call to the recipient apparatus 1B according to the operation of the sender (ST1) and informs the apparatus 1B of its terminal number. In the recipient apparatus 1B, the exclusive control section 11 brings only the calling sender terminal A1 among a plurality of sender terminals A1 to Aj into the operable state and the other sender terminals A2 to Ai into the inoperable state. That is, the exclusive control section 11 performs exclusive control (ST2).

In the recipient apparatus 1B, the random number generator 12 generates two different random numbers k, x which have the same bit length. The random generator 12 sets one random number k as a basis set identifying value k and the other random number x as a bit value x. The random number generator 12 determines the random numbers k, x to be private keys k, x respectively and stores them in the storage unit 13 in secret.

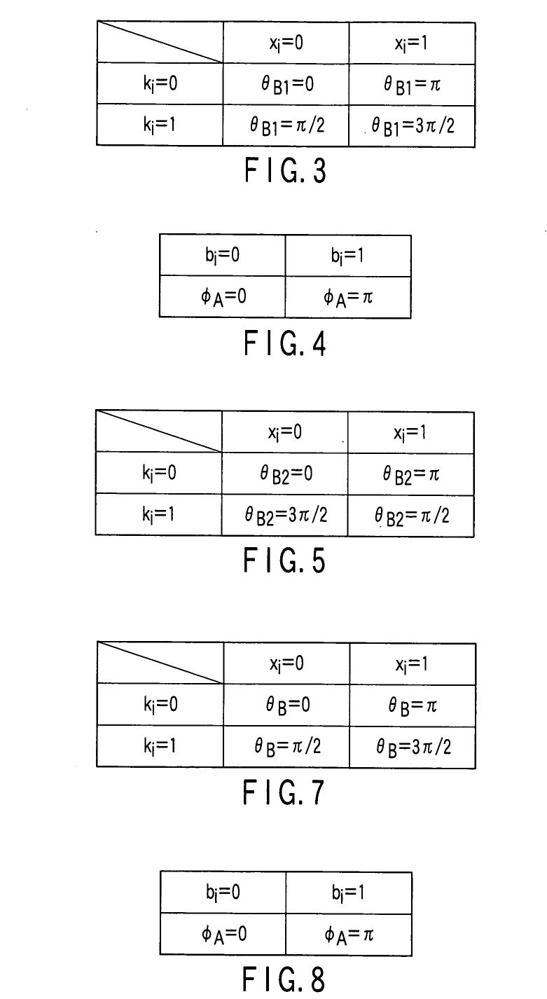

Next, on the basis of the private keys k, x, the recipient apparatus 1B sets the value of a phase delay θ_{B1} as shown in FIG. 3 in the first phase modulator 15.

Thereafter, in the recipient apparatus 1B, the single photon source 14 generates a single photon pulse (ST3). The single photon pulse is divided via the first beam splitter BS1 into two quantum states. The two quantum states are a first and a second quantum state. Of the first and second quantum states, the first one passes through the first phase modulator 15. When the first quantum state passes through, the first phase modulator 15 changes the phase of the first quantum state by θ_{B1} on the basis of the private keys k, x. By doing this, the first phase modulator 15 encodes the first quantum state using the private keys k, x (ST4) and outputs the public key quantum state (|x>ₖ), the result of the encoding, to the sender terminal A1. The public key quantum state is transmitted to the sender terminals A1 to Aj via the public quantum channel QC1 (ST5). On the other hand, the second quantum state output from the first beam splitter BS1 is sent to the delay line DL in its own apparatus 1B.

In the sender terminal A1, the authenticator processing section 2 converts N-bit message information m in the message storage section 1 into an authenticator H(m) on the basis of a previously opened function H. The authenticator processing section 2 generates concatenated data m|H(m) obtained by bit-concatenating the message information m and authenticator H(m). The function H is conversion where bit-position dependence between the message information m and the authenticator H(m) is unobvious. In the first embodiment, a hash function is used as the function H. Then, in the sender terminal A1, the authenticator processing section 2 sets the value of a phase delay θ_{A} as shown in FIG. 4 according to each bit value b in the concatenated data m|H(m).

The sender terminal A1 receives the public key quantum state of a single photon pulse via the public quantum channel QC1 and first reflecting mirror M1. On the basis of each bit value b in the concatenated data m|H(m), the phase modulator 3 of the sender terminal A1 inverts the phase of the public key quantum state, while maintaining the basis set k of the public key quantum state (|x>ₖ). By doing this, the phase modulator 3 encodes the public key quantum state using the concatenated data m|H(m) (ST6) and outputs the encrypted text quantum state (|x(+)[m|H(m)]>k). The symbol “(+)” in the specification means exclusive OR. The encrypted text quantum state is transmitted to the recipient apparatus 1B via the other inoperable sender terminals A2 to Aj, second reflecting mirror M2, and public quantum channel QC2 (ST7).

The recipient apparatus 1B sets the value of a phase delay θ_{B2} as shown in FIG. 5 in the second phase modulator 16 according to the private keys (k, x) in the storage unit 13.

Then, the recipient apparatus 1B receives the encrypted text quantum state from the sender terminal A1 via the quantum public channel QC2 and others. On the basis of the public keys k, x in the storage unit 13, the second phase modulator 16 changes the phase of the encrypted text quantum state so as to offset a variation θ_{B1} in the phase caused by the first phase modulator 15 from the encrypted text quantum state. The plain text quantum state (|m|H(m)>ₖ), the result of changing the phase, is output from the second phase modulator 16 to the second beam splitter BS2.

The second beam splitter BS2 mixes the plain text quantum state with the second quantum state passed through the delay line DL. Of the two quantum states, the result of the mixing, one quantum state is output from the second beam splitter BS2 to the first photon detector PD1. The other quantum state is output from the second beam splitter BS2 to the second photon detector PD2.

When sensing a single photon from the quantum state, the first photon detector PD1 sends bit “0” to the information identifying section 17. The bit “0” corresponds to the state where the phase (φA=0) of the plain text quantum state and the phase of the second quantum state coincide with each other.

When sensing a single photon from the quantum state, the second photon detector PD2 sends bit “1” to the information identifying section 17. The bit “1” corresponds to the state where the phase (φA=n) of the plain text quantum state and the phase of the second quantum state are opposite to each other. That is, the photon detectors PD1, PD2 are provided so as to detect the phase of a single photon.

The information identifying section 17 receives each bit from each of the photon detectors PD1, PD2. The information identifying section 17 identifies a bit train from the first bit to the N-th bit as message information m′ and a bit train from the (N+1)-th and later bits as an authenticator a. Thereafter, the information identifying section 17 writes the message information m′ and authenticator a into the storage unit 18. The operations from the change of the phase by the second phase modulator 16 to the identification by the information identifying section 17 correspond to the operation of decrypting the message information and authenticator from the encrypted text (ST8).

Next, the authenticator verifying section 19 verifies whether the message information m′ and authenticator a in the storage unit 18 are consistent with each other (ST9). Specifically, the authenticator verifying section 19 calculates an authenticator H(m′) from the message information m′ in the storage unit 18. Then, the authenticator verifying section 19 compares the authenticator H(m′), the result of the calculation, with the authenticator a obtained from the measurement. Moreover, the authenticator verifying section 19 determines whether the authenticator H(m′) coincides with the authenticator a. The result of the determination is sent from the authenticator verifying section 19 to the cipher communication control section 20.

If the result of the determination has shown that they coincide with each other, the cipher communication control section 20 regards the message information m′ in the storage unit 18 as authorized message information and accepts it and continues the next cipher communication (ST10).

If the result of the determination has shown that they differ from each other and do not coincide with each other (in the case of NO), the cipher communication control section 20 regards the message information m′ in the storage unit 18 as unauthorized message information and discards it and interrupts a subsequent cipher communication (ST11). The cipher communication control section 20 may not discard the unauthorized message information and has only to invalidate it. For example, the cipher communication control section 20 may not discard the unauthorized message information and may add invalidating information to the unauthorized message information.

As described above, in the first embodiment, the public key quantum state obtained by encrypting the first quantum state of a single photon pulse using the private keys k, x is output. The encrypted text quantum state obtained by encrypting the public key quantum state using the message information and authenticator is received. Then, the encrypted text quantum state is decrypted using the private key, thereby obtaining the message information and authenticator. Here, the public key quantum state and encrypted text quantum state are both in a quantum state. According to the uncertainty principle, a quantum state is changed at random, when being measured. Therefore, if the public key quantum state or encrypted text quantum state during communication is intercepted or falsified, the quantum state will be destroyed, which enables interception or the like to be detected by the verification of the authenticator. At this time, if the intercepted quantum state can be copied accurately, this will prevent the detection. However, to make an accurate copy, it is necessary to know the quantum state accurately. Here, to know the quantum state accurately, a measurement system in the same basis set as that of the public key is required. However, the basis set of the public key is changed by a random number. Therefore, the eavesdropper cannot prevent the interception from being detected. When a measurement system in a basis set different from the basis set of the public key is used, the quantum state is randomized and measured under the uncertainty principle. For this reason, it is impossible to obtain the correct measurements of all the bits in terms of probability.

Therefore, it is possible to realize a public key encryption method which can guarantee security on the basis of the uncertainty principle, is safe from quantum-computer-based attacks, and can be practiced in the present state of the art.

Specifically, since an accurate copy of the quantum state is prevented on the basis of the basic principle of the quantum theory and a one-way function which assures inverse operation difficulty, eavesdropping and the like can be detected, which guarantees security. Furthermore, since the method is not based on an unproven mathematical assumption (or calculation amount difficulty), it is safe from quantum-computer-based attacks. Moreover, since the method does not use techniques (e.g., quantum memory or quantum computer) which cannot be practiced in the present state of the art, it can be implemented in the present state of the art.

However, if a quantum memory has been realized, the first embodiment can be modified into a configuration which enables decryption with arbitrary timing. In this case, for example, the sender terminal A1 stores the encrypted text quantum state into a first quantum memory and the recipient apparatus 1B stores the second quantum state in the delay line DL into a second quantum memory. Thereafter, the sender terminal A1 transmits the encrypted text quantum state in the first quantum memory to the recipient apparatus 1B with arbitrary timing. The recipient apparatus 1B operates the second phase modulator 16 according to the private keys k, x in the storage unit 13 in synchronization with the timing and, at the same time, inputs the second quantum state in the second quantum memory to the second beam splitter BS2. This produces not only the above-described effect but also the effect of shifting encryption timing to arbitrary one.

### SECOND EMBODIMENT

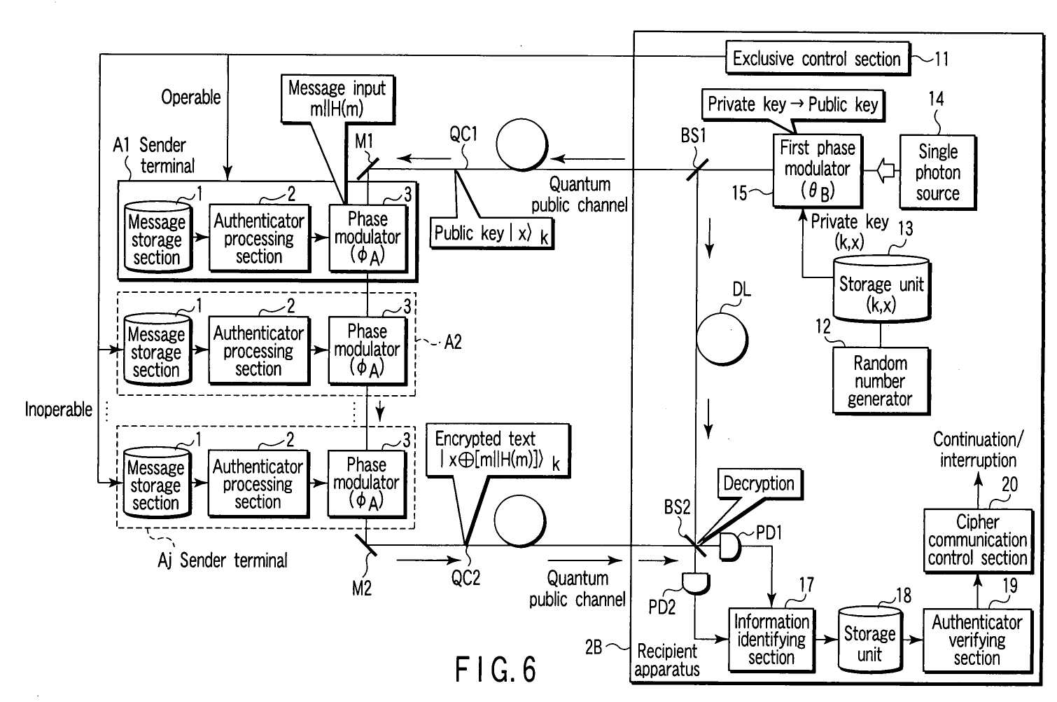

FIG. 6 is a schematic diagram showing the configuration of a public key encryption apparatus according to a second embodiment of the present invention. The same parts as those in FIG. 1 are indicated by the same reference numerals and a detailed explanation of them will be omitted. The parts differing from those in FIG. 1 will be mainly explained. Similarly, in the embodiments explained below, a repeated explanation will be omitted.

The second embodiment, which is a modification of the first embodiment, simplifies the configuration of the first embodiment. Specifically, the second embodiment is so configured that the second phase modulator 16 of FIG. 1 is removed and the first phase modulator 15 is placed between the first beam splitter BS1 and the single photon source 14.

Next, the operation of the public key encryption apparatus configured as described above will be explained using a flowchart in FIG. 2.

First, as described above, the recipient apparatus 2B brings only the calling sender terminal A1 into the operable state and the other sender terminals A2 to Ai into the inoperable state. That is, the recipient apparatus 2B performs exclusive control (ST1, ST2).

Moreover, the recipient apparatus 2B sets the random numbers k, x generated by the random number generator 12 as private keys k, x and stores these keys into the storage unit 13 in secret.

Next, on the basis of the private keys k, x, the recipient apparatus 2B sets the value of a phase delay θ_{B} as shown in FIG. 7 in the first phase modulator 15.

Thereafter, in the recipient apparatus 2B, the single photon source 14 generates a single photon pulse (ST3) and causes the single photon pulse to pass through the first phase modulator 15. When the pulse passes through, the first phase modulator 15 changes the phase of the single photon pulse by θ_{B} on the basis of the private keys k, x. By doing this, the first phase modulator 15 encodes the single photon pulse using the private keys k, x (ST4). The first phase modulator 15 outputs the single photon pulse as a public key, the result of the encoding, to the first beam splitter BS1.

The first beam splitter BS1 divides the single photon pulse encoded as the public key into two quantum states and outputs a first public key quantum state (|x>ₖ), one of the divisions, to the sender terminal A1. The public key quantum state is transmitted to the sender terminals A1 to Aj via the public quantum channel QC1 (ST5). A second public key quantum state, the other of the divisions, is sent from the first beam splitter BS1 to the delay line DL.

As described above, in the sender terminal A1, the authenticator processing section 2 obtains an authenticator H(m) from N-bit message information m in the message storage section 1 and creates concatenated data m|H(m) obtained by bit-concatenating the message information m and authenticator H(m). Then, the authenticator processing section 2 sets the value of a phase delay θ_{A} as shown in FIG. 8 according to each bit value b in the concatenated data m|H(m).

The sender terminal A1 receives the public key quantum state of a single photon pulse via the public quantum channel QC1 and first reflecting mirror M1. Thereafter, on the basis of each bit value b of the concatenated data m|H(m), the phase modulator 3 inverts the phase of the public key quantum state, while maintaining the basis set k of the public key quantum state (|x>ₖ). By doing this, the phase modulator 3 encodes the public key quantum state using the concatenated data m|H(m) (ST6) and outputs the encrypted text quantum state (|x (+) [m|H(m)]>ₖ), the result of the encoding as described above. The encrypted text quantum state is transmitted to the recipient apparatus 2B via the public quantum channel QC2 and others (ST7).

The recipient apparatus 2B receives the encrypted text quantum state from the sender terminal A1 via the quantum public channel QC2 and others. The encrypted text quantum state is input to the second beam splitter BS2.

The second beam splitter BS2 mixes the encrypted text quantum state with the second public key quantum state passed through the delay line DL. Two quantum states, the result of the mixing, are output separately to the first and second photon detectors PD1, PD2.

Hereinafter, as described above, the first and second photon detectors PD1, PD2 detect a single photon. The information identifying section 17 identifies the message information m′ and authenticator a and writes them. The authenticator verifying section 19 performs verification. Then, the cipher communication control section 20 accepts or invalidates the message information m′.

As described above, the second embodiment is such that the configuration is simplified by eliminating the second phase modulator 16 of FIG. 1. Even such a configuration produces the same effect as that of the first embodiment.

### THIRD EMBODIMENT

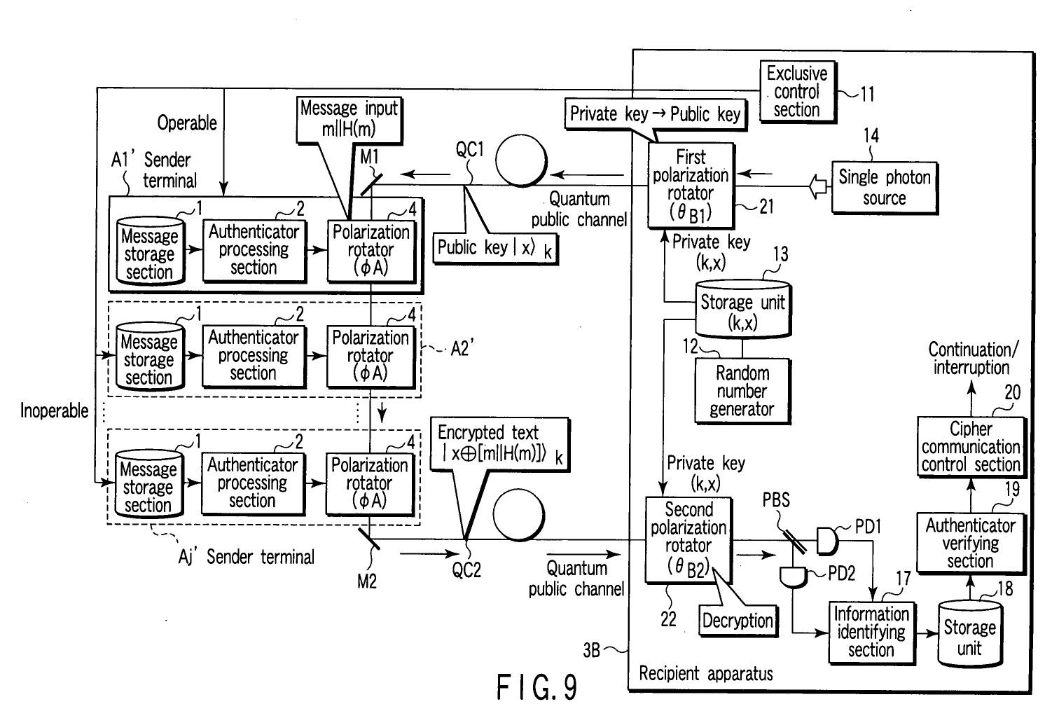

FIG. 9 is a schematic diagram showing the configuration of a public key encryption apparatus according to a third embodiment of the present invention.

The third embodiment, which is a modification of the first embodiment, performs encoding in ST4 and ST6 of FIG. 2 by the rotation of the polarization component, not by a phase delay. Specifically, a recipient apparatus 3B has a first and a second polarization rotator 21, 22 in place of the first and second phase modulators 15, 16. Sender terminals A1′ to Aj′ each has a polarization rotator 4 in place of the phase modulator 3. In the recipient apparatus 3B, the first beam splitter BS1 and delay line DL are eliminated. In the recipient apparatus 3B, a polarizing beam splitter PBS is provided in place of the second beam splitter BS2.

Here, on the basis of each bit value of the message information and authenticator concatenated by the authenticator processing section 2, the polarization rotator 4 rotates the polarization component through n/2 radians, while maintaining the basis set of the public key quantum state output from the recipient apparatus 3B. The polarization rotator 4 outputs the encrypted text quantum state, the result of rotating the polarization component, onto the public quantum channel QC2 toward the recipient apparatus 3B via the other sender terminals A2′ to Aj′.

On the other hand, the first polarization rotator 21 changes the polarization component of the single photon pulse generated by the single photon source 14 on the basis of the private keys k, x in the storage unit 13. The first polarization rotator 21 outputs the public key quantum state, the result of changing the polarization component, onto the quantum public channel QC1 toward the sender apparatus A1.

The second polarization rotator 22 receives the encrypted text quantum state from the sender terminal A1 via the quantum public channel QC2 and others. Here, the encrypted text quantum state is obtained by rotating the polarization component of the public key quantum state by n/2 radians according to each bit in the message information and authenticator. The second polarization rotator changes the polarization component of the encrypted text quantum state on the basis of the private keys k, x so as to offset a variation in the polarization component caused by the first polarization rotator 21 from the encrypted text quantum state. The second polarization rotator 22 outputs a plain text quantum state, the result of changing the polarization component of the encrypted text quantum state, to the polarizing beam splitter PBS.

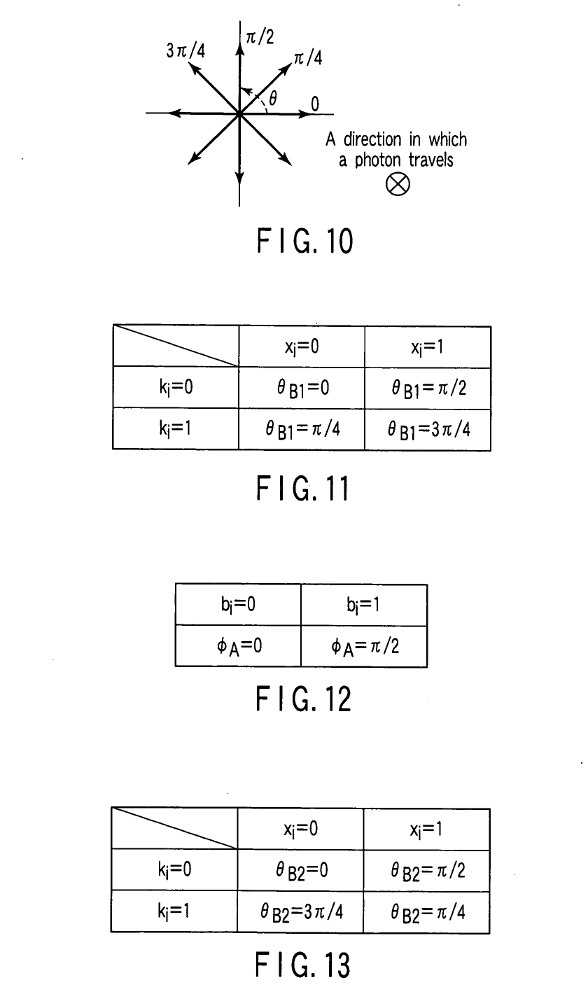

When the direction φ_{A} Of linearly polarized light in the plain text quantum state received from the second polarization rotator 22 is 0 radian, the polarizing beam splitter PBS causes a single photon pulse having the plain text quantum state to pass through the first-photon detector PD1. Moreover, when the direction φ_{A} of linearly polarized light in the plain text quantum state received from the second polarization rotator 22 is n/2 radians, the polarizing beam splitter PBS reflects a single photon pulse having the plain text quantum state toward the second photon detector PD2. Here, it is assumed that the direction of linearly polarized light is as shown in FIG. 10.

Therefore, the single photon source 14 generates a single photon pulse whose linearly polarized light components are all in a direction in which they can pass through the polarizing beam splitter PBS.

Next, the operation of the public key encryption apparatus configured as described above will be explained using the flowchart of FIG. 2.

First, as described above, the recipient apparatus 3B performs exclusive control which brings only the calling sender terminal A1 into the operable state (ST1, ST2). Moreover, the recipient apparatus 3B stores the random numbers k, x generated by the random number generator 12 as private keys k, x into the storage unit 13 in secret.

Next, on the basis of the private keys k, x, the recipient apparatus 3B sets the value of a rotation angle θ_{B1} as shown in FIG. 11 in the first polarization rotator 21.

Thereafter, in the recipient apparatus 3B, the single photon source 14 generates a single photon pulse whose polarization components are in the same direction (ST3). Here, suppose they are brought into linearly polarized light in the horizontal direction. Hereinafter, when the rotation angle of the polarization components is described, the counterclockwise direction is determined to be a positive direction, taking into account the direction in which the single photon pulse travels (from the front to back of the figure).

Next, the recipient apparatus 3B causes the single photon pulse generated by the single photon source 14 to pass through the first polarization rotator 21. When the single photon pulse passes through, the first polarization rotator 21 changes the polarization component of the single photon pulse by θ_{B1} on the basis of the private keys k, x. By doing this, the first polarization rotator 21 encodes the single photon pulse as a public key using the private keys k, x (ST4). The first polarization rotator 21 outputs the public key quantum state (|x>ₖ), the result of the encoding, toward the sender terminal A1. The public key quantum state is transmitted to the sender terminals A1 to Aj via the public quantum channel QC1 (ST5).

In the sender terminal A1, as described above, the authenticator processing section 2 obtains an authenticator H(m) from the N-bit message information m in the message storage section 1 and creates concatenated data m|H(m) obtained by bit-concatenating the message information m and authenticator H(m). Then, the authenticator processing section 2 sets the value of the rotation angle θ_{A} of the linearly polarized light as shown in FIG. 12 according to each bit value b of the concatenated data m|H(m).

The sender terminal A1 receives the public key quantum state of the single photon pulse via the public quantum channel QC1 and first reflecting mirror M1. On the basis of each bit value b in the concatenated data m|H(m), the polarization rotator 4 rotates the direction of linearly polarized light by φ_{A}, while maintaining the basis set k of the public key quantum state (|x>ₖ). By doing this, the polarization rotator 4 encodes the public key quantum state using the concatenated data m|H(m) (ST6) and outputs the encrypted text quantum state (|x(+)[m|H(m)>ₖ]. As described above, the encrypted text quantum state is transmitted to the recipient apparatus 3B via the public quantum channel QC2 and others (ST7).

On the basis of the private keys k, x, the recipient apparatus 3B sets the value of a rotation angle θ_{B2} of linearly polarized light as shown in FIG. 13 in the second polarization rotator 22.

Then, receiving the encrypted text quantum state from the sender terminal A1 via the quantum public channel QC and others, the recipient apparatus 3B inputs the encrypted text quantum state to the second polarization rotator 22.

The polarization rotator 22 rotates the polarization component of the linearly polarized light in the encrypted text quantum state by θ_{B2} so as to offset a variation in the polarization component caused by the first polarization rotator 21 from the encrypted text quantum state. The second polarization rotator 22 outputs a plain text quantum state, the result of rotating the polarization component, to the polarizing beam splitter PBS.

When the direction φ_{A} of linearly polarized light in the plain text quantum state is 0 radian, the polarizing beam splitter PBS causes a single photon pulse having the plain text quantum state to pass through the first photon detector PD1. Moreover, when the direction φ_{A} of linearly polarized light in the plain text quantum state is n/2 radians, the polarizing beam splitter PBS reflects a single photon pulse having the plain text quantum state toward the second photon detector PD2.

Hereinafter, as described above, the first and second photon detectors PD1, PD2 detect a single photon. The information identifying section 17 identifies the message information m′ and authenticator a and writes them. The authenticator verifying section 19 performs verification. Then, the cipher communication control section 20 accepts or invalidates the message information m′.

As described above, the third embodiment is so configured that encoding in ST4 and ST6 is done by rotating the polarization component, not by delaying the phase. Even such a configuration produces the same effect as that of the first embodiment.

### FOURTH EMBODIMENT

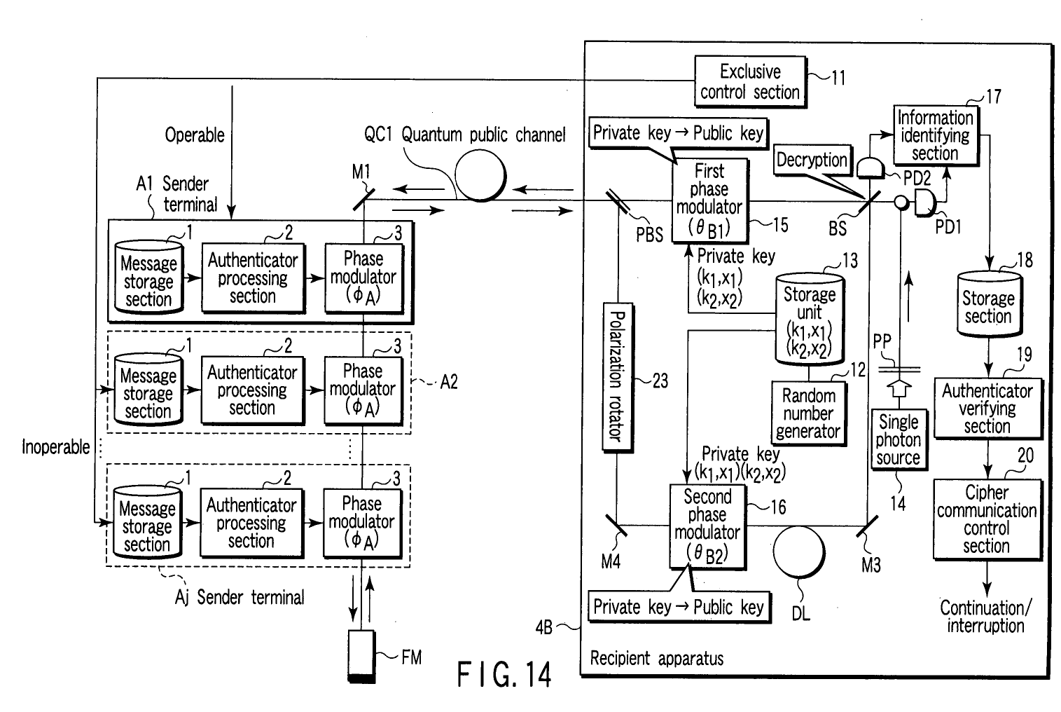

FIG. 14 is a schematic diagram showing the configuration of a public key encryption apparatus according to a fourth embodiment of the present invention.

The fourth embodiment, which is a modification of the first embodiment, shares the quantum public channel QC in transmission and in reception. Specifically, the fourth embodiment includes a Faraday mirror FM in place of the second quantum public channel QC and second reflecting mirror MC. In addition, the fourth embodiment includes a polarizing plate PP, a beam splitter BS, a third and a fourth reflecting mirror M3, M4, a delay line DL, a polarization rotator 23, and a polarizing beam splitter PBS in place of the beam splitters BS1, BS2 and delay line DL shown in FIG. 1.

Here, the polarizing plate PP polarizes a single photon pulse output from the single photon source and causes the pulse to pass through the plate.

The beam splitter BS divides the single photon pulse passed through the polarizing plate PP and outputs a first quantum state to the first phase modulator 15 and a second quantum state to the third reflecting mirror M3.

The third reflecting mirror M3 reflects a single photon pulse having the second quantum state received from the beam splitter BS to the delay line DL and outputs the resulting pulse to the second phase modulator 16 side.

The fourth reflecting mirror M4 is a reflecting mirror which is placed on an optical path between the second phase modulator 16 and polarization rotator 23 and optically connects them.

The polarization rotator 23 rotates the polarization component of the first public key quantum state reflected by the polarizing beam splitter PBS by n/2 radians and outputs the resulting component to the second phase modulator 16 side. Moreover, the polarization rotator 23 rotates the polarization component of the second public key quantum state reflected by the fourth reflecting mirror M4 by n/2 radians and outputs the resulting component toward the polarizing beam splitter PBS. As the polarization rotator 23, for example, a combination of two half-wavelength plates or a component corresponding to a Faraday element can be used. In the fourth embodiment, a Faraday element is used as the polarization rotator 23.

The polarizing beam splitter PBS has the function of causing the first public key quantum state output from the first phase modulator 15 to pass through the splitter toward the sender apparatuses A1 to Aj. Moreover, the polarizing beam splitter PBS has the function of reflecting the first public key quantum state received from the sender apparatus A1 toward the polarization rotator 23. The first public key quantum state received from the sender apparatus A1 is obtained by rotating the polarization component of the first public key quantum state passed through by n/2 radians at the Faraday mirror FM.

Furthermore, the polarizing beam splitter PBS has the function of reflecting the second public key quantum state input from the polarization rotator 23 toward the sender apparatuses A1 to Aj. Furthermore, the polarizing beam splitter PBS has the function of causing the second encrypted text quantum state received from the sender apparatus A1 toward the first phase modulator 15. The second encrypted text quantum state received from the sender apparatus A1 is obtained by rotating the polarization component of the reflected second public key quantum state by n/2 radians at the Faraday mirror FM and inverting the phase of the second public key quantum state according to each bit in the message information and authenticator.

Next, the operation of the public key encryption apparatus configured as described above will be explained using the flowchart of FIG. 2.

First, as described above, the recipient apparatus 4B performs exclusive control which brings only the calling sender terminal A1 into the operable state and the other sender terminals A2 to Ai into the inoperable state (ST1, ST2).

In the recipient apparatus 4B, the random number generator 12 generates two different random numbers which have the same bit length and determines one random number k to be a basis set identifying value k and the other random number x to be a bit value x. The recipient apparatus 1B stores two sets of private keys (ki, xi) (i=1, 2) using the random numbers k, x as a set into the storage unit 13 in secret.

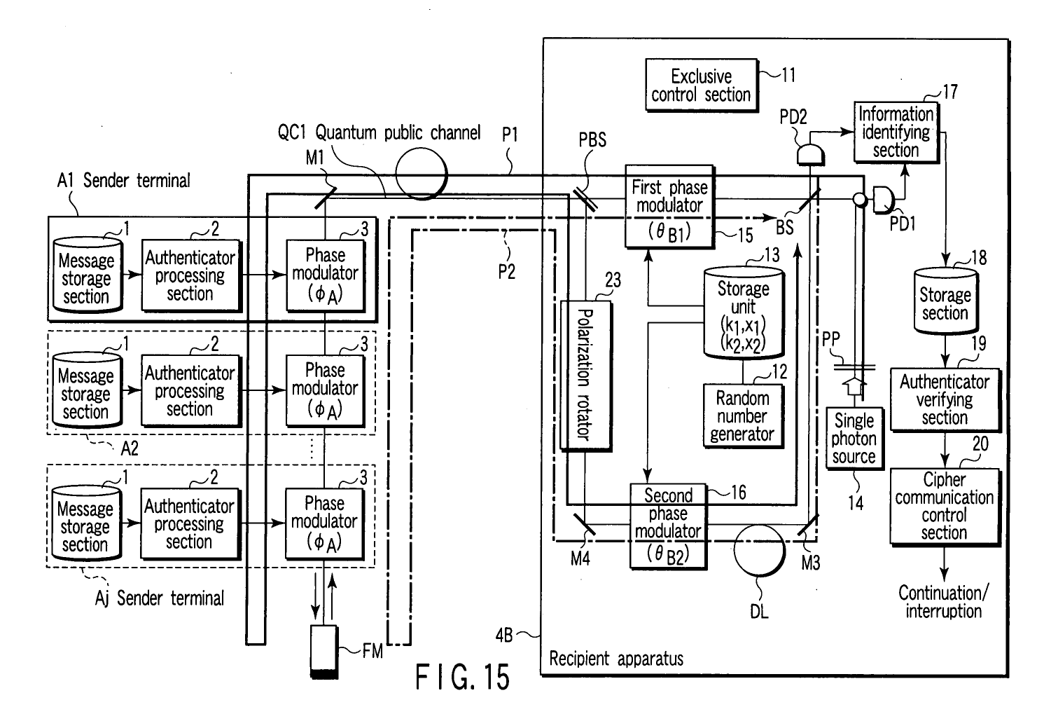

In the recipient apparatus 4B, the single photon source 14 generates a single photon pulse and the beam splitter BS divides the single photon pulse. Here, as shown in FIG. 15, a single photon pulse having the first quantum state which passes through the beam splitter BS is referred to as pulse P1. A single photon pulse having the second quantum state which is reflected by the beam splitter BS is referred to as pulse P2. A path for pulse P1 is referred to as a first path and a path for pulse P2 is referred to as a second path.

(Pulse P1 in the First Path)

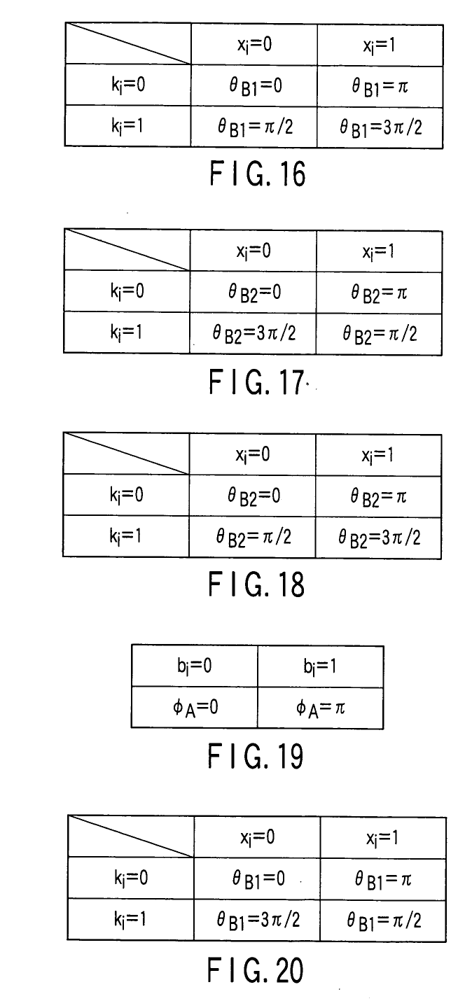

The recipient apparatus 4B causes the first phase modulator 15 to operate at a high speed in synchronization with the time when pulse P1 passes through. According to the private keys (k1, x1), the first phase modulator 15 sets, as shown in FIG. 16, a phase delay θ_{B1} to be generated. The first phase modulator 15 encodes pulse P1 using the private keys k1, x1 (ST4). The first phase modulator 15 outputs pulse P1 having the first public key quantum state (|x1>ₖ₁), the result of the encoding, to the polarizing beam splitter PBS.

Pulse P1 passes through the polarizing beam splitter PBS. The polarization components of pulse P1 are put in the same direction beforehand at the time of generation so as to pass through the polarizing beam splitter PBS. Pulse P1 passes through the public quantum channel QC1 and is transmitted to the sender terminals A1 to Aj (ST5).

The sender terminal A1 does not operate the phase modulator 3 when pulse P1 passes through. The Faraday mirror FM rotates the polarization components of pulse P1 by n/2. After the rotation of the polarization components, pulse P1 passes through the public quantum channel QC1 again and reaches the polarizing beam splitter PBS of the recipient apparatus 4B.

Since the polarization components have been changed at the Faraday mirror FM, pulse P1 is reflected by the polarizing beam splitter PBS toward the polarization rotator 23. After the reflection, pulse P1 has its polarization components rotated by the polarization rotator 23 by −n/2 radians and then passes through the second phase modulator 16 via the fourth reflecting mirror M4.

The second phase modulator 16 operates in synchronization with the time when pulse P1 passes through. The second phase modulator 16 changes the phase of the first public key quantum state by the phase delay θ_{B2} set as shown in FIG. 17 on the basis of the private keys (k1, x1) so as to offset a variation in the phase caused by the first phase modulator 15 from the first public key quantum state of pulse P1. The phase modulator 16 outputs pulse P1 having the first quantum state, the result of changing the phase. The output pulse P1 is input to the beam splitter BS via the delay line DL and third reflecting mirror M3.

(Pulse P2 in the Second Path)

The recipient apparatus 4B causes the second phase modulator 16 to operate at a high speed in synchronization with the time when pulse P2 passes through. According to the private keys (k2, x2), the second phase modulator 16 sets the value of a phase delay θ_{B2} as shown in FIG. 18 and encodes pulse P2 (ST4). The second phase modulator 16 outputs pulse P2 having the second public key quantum state (|x2>ₖ₂), the result of the encoding.

Thereafter, pulse P2 has its polarization components rotated by the polarization rotator 23 by n/2 radians and is reflected by the polarizing beam splitter PBS. The reflected pulse P2 passes through the public quantum channel QC1 and is transmitted to the sender terminals A1 to Aj (ST5).

As described above, in the sender terminal A1, the authenticator processing section 2 obtains an authenticator H(m) from N-bit message information m in the message storage section 1 and generates concatenated data m|H(m) obtained by bit-concatenating the message information m and authenticator H(m).

The sender terminal A1 does not operate the phase modulator 3 when pulse P2 passes through for the first time. Pulse P2 is reflected by the Faraday mirror FM. At this time, the polarization component is rotated by n/2 radians. The sender terminal A1 operates the phase modulator 3 at a high speed in synchronization with the time when the reflected pulse P2 passes through. The phase modulator 3 sets the value of a phase delay φ_{A} as shown in FIG. 19 according to the bit value B to be encoded and encodes pulse P2 (ST6). The phase modulator 3 outputs pulse P2 having the second encrypted text quantum state (|x2(+)[m|H(m)]>ₖ₂), the result of the encoding.

The pulse P2 passes through the public quantum channel QC1 again and reaches the polarizing beam splitter PBS of the recipient apparatus 4B.

Since the polarization components have been changed at the Faraday mirror FM, the pulse P2 passes through the polarizing beam splitter PBS. The recipient apparatus 4B operates the first phase modulator 15 at a high speed in synchronization with the time when pulse P2 passes through. The first phase modulator 15 offsets a variation in the phase caused by the second phase modulator 16 from the second encrypted text quantum state of pulse P2. Specifically, the first phase modulator 15 changes the phase of the second encrypted text quantum state by a phase delay of θ_{B1} on the basis of the private keys (k2, x2). The phase delay θ_{B1} is set in the first phase modulator 15 on the basis of the private keys (k2, x2) as shown in FIG. 20.

Thereafter, the first phase modulator 15 outputs pulse P2 having a second plain text state (|m|H(m)>ₖ₂), the result of changing the phase. The pulse P2 passes through the first phase modulator 15 and then is input to the beam splitter BS.

(Mixing and Verifying Process of Pulses P1 and P2)

Pulses P1, P2 are mixed with each other at the beam splitter BS. They are output as two quantum states, the result of the mixing, to the first and second photon detectors PD1, PD2.

Hereinafter, as described above, the first and second photon detectors PD1, PD2 detect a single photon. The information identifying section 17 identifies the message information m′ and authenticator a and writes them. The authenticator verifying section 19 performs verification. Then, the cipher communication control section 20 accepts or invalidates the message information m′.

As described above, the fourth embodiment is so configured that the quantum public channel QC1 in transmission and in reception is shared using the Faraday mirror FM. Even such a configuration produces the same effect as that of the first embodiment. In addition, since the quantum public channel QC1 in transmission and in reception is shared, this eliminates the disadvantage of permitting the transmission and reception optical fibers (or quantum public channels) to extend differently from each other. Therefore, it is possible to provide a public key encryption apparatus suitable for long-distance communication.

### FIFTH EMBODIMENT

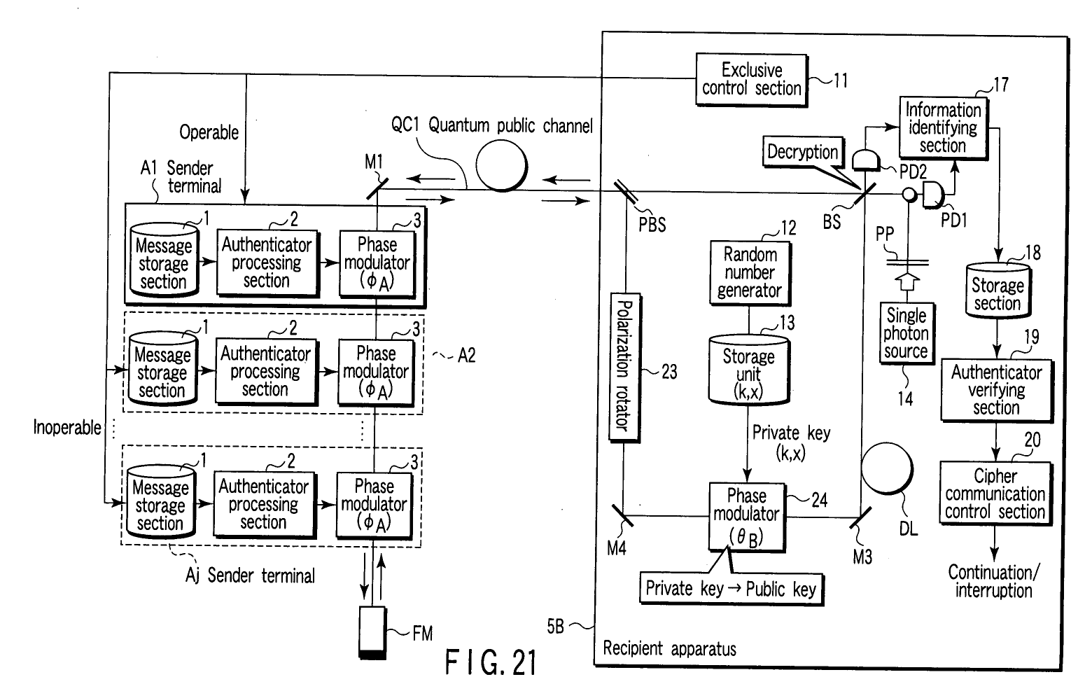

FIG. 21 is a schematic diagram showing the configuration of a public key encryption apparatus according to a fifth embodiment of the present invention.

The fifth embodiment, which is a modification of the fourth embodiment, simplifies the configuration of the fourth embodiment. Specifically, the fifth embodiment is so configured that the first phase modulator 15 of FIG. 14 is removed. Thus, the second phase modulator 16 is just referred to as a phase modulator 24.

The phase modulator 24 changes the phase of a first quantum state output from the polarization rotator 23 on the basis of the private keys k, x in the storage unit 13. The phase modulator 24 has the function of outputting the first public key quantum state (|x>ₖ), the result of changing the phase of the first quantum state, to the reflecting mirror M3. The phase modulator 24 changes the phase of the second quantum state on the basis of the private keys k, x in the storage unit 13. The phase modulator 24 also has the function of outputting the second public key quantum state (|x>ₖ), the result of changing the phase of the second quantum state, to the fourth reflecting mirror M4.

Next, the operation of the public key encryption apparatus configured as described above will be explained using the flowchart of FIG. 2.

First, as described above, the recipient apparatus 4B performs exclusive control which brings only the calling sender terminal A1 into the operable state and the other sender terminals A2 to Ai into the inoperable state (ST1, ST2).

In the recipient apparatus 5B, the random number generator 12 generates two different random numbers k, x which have the same bit length and determines one random number k to be a basis set identifying value k and the other random number x to be a bit value x. The recipient apparatus 5B stores the random numbers k, x as a set of private keys into the storage unit 13 in secret.

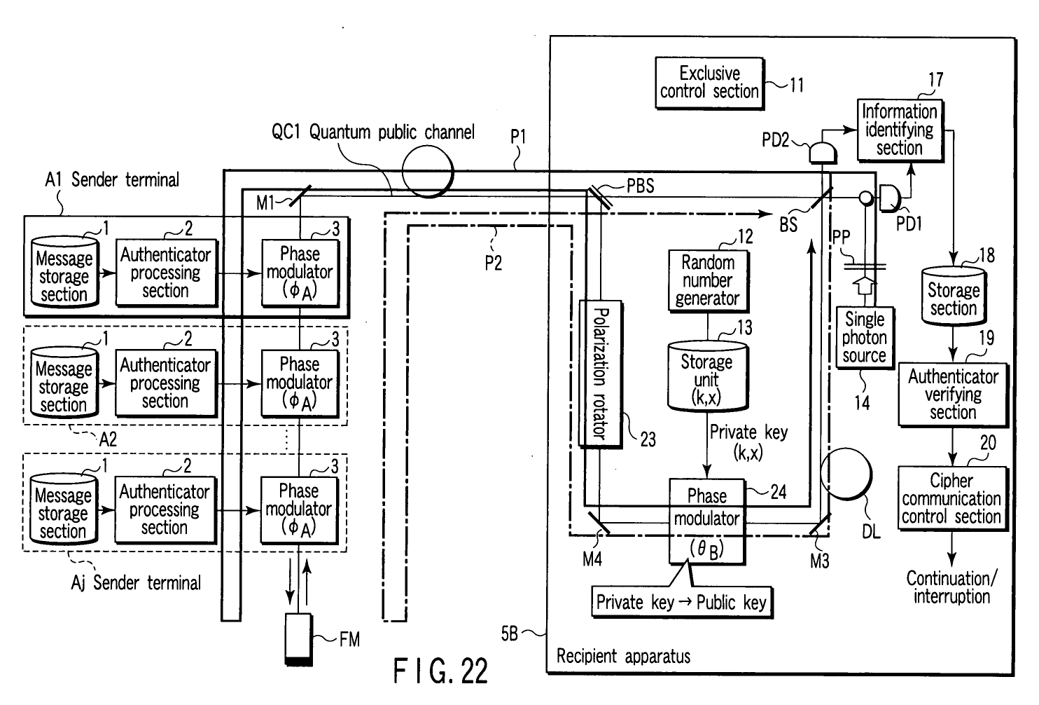

In the recipient apparatus 5B, the single photon source 14 generates a single photon pulse and the beam splitter BS divides the single photon pulse. Here, as shown in FIG. 22, a single photon pulse having the first quantum state which passes through the beam splitter BS is referred to as pulse P1. A single photon pulse having the second quantum state which is reflected by the beam splitter BS is referred to as pulse P2. A path for pulse P1 is referred to as a first path and a path for pulse P2 is referred to as a second path.

(Pulse P1 in the First Path)

The recipient apparatus 5B causes pulse P1 having the first quantum state to pass through the polarizing beam splitter PBS and transmits pulse P1 via the public quantum channel QC1 to the sender terminals A1 to Aj (ST5)

The sender terminal A1 does not operate the phase modulator 3 at the time when pulse P1 passes through. The Faraday mirror FM rotates the polarization components by n/2 radians. After the rotation of the polarization components, pulse P1 passes through the public quantum channel QC1 again and reaches the polarizing beam splitter PBS of the recipient apparatus 4B.

As described above, the pulse P1 is reflected by the polarizing beam splitter PBS. After the polarization components are rotated by the polarization rotator 23 by −n/2 radians, the pulse P1 passes through the phase modulator 24 via the fourth reflecting mirror M4.

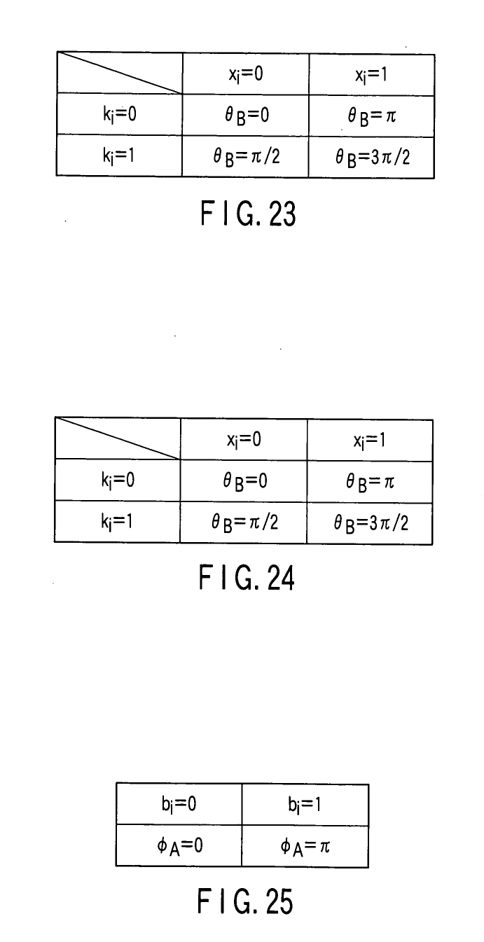

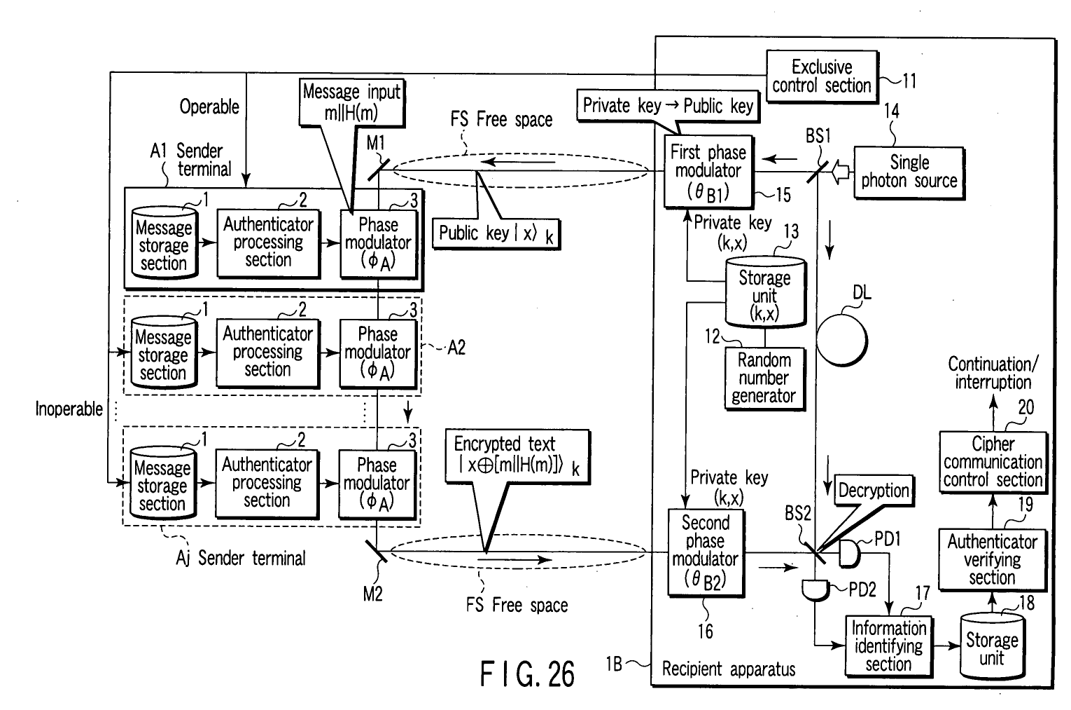

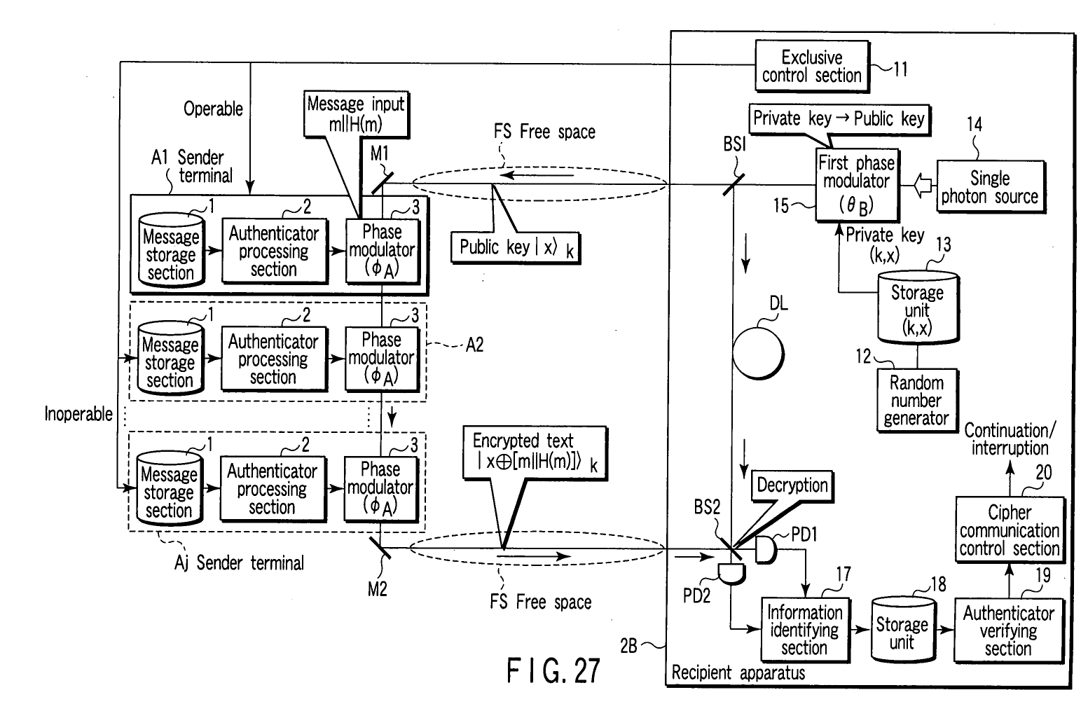

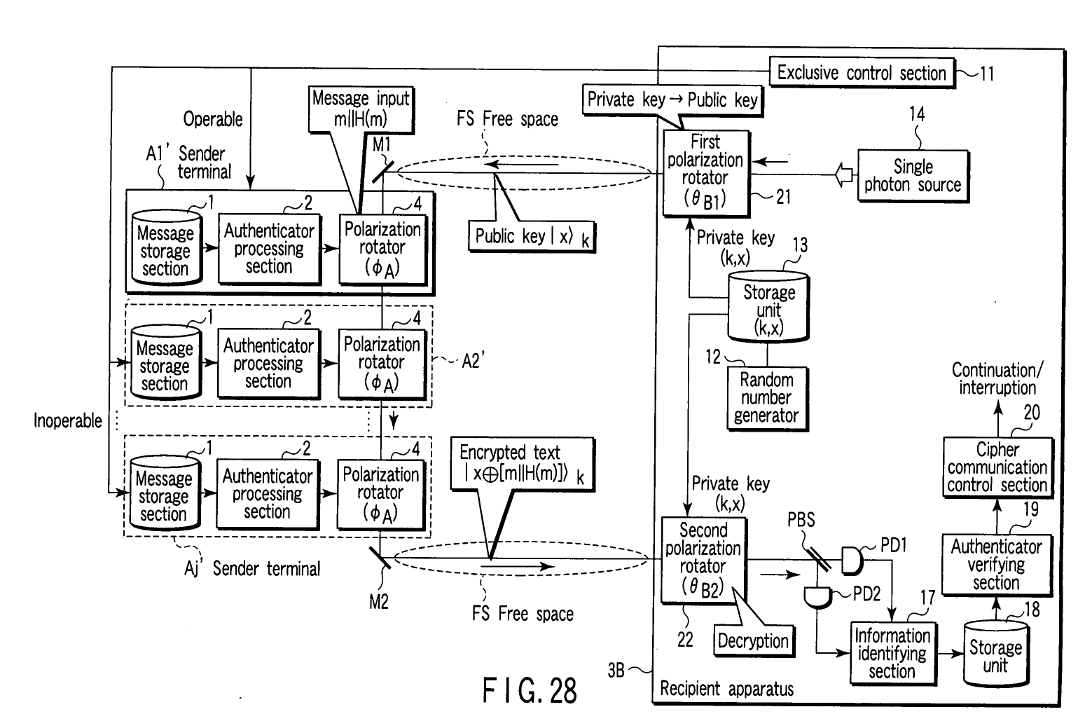

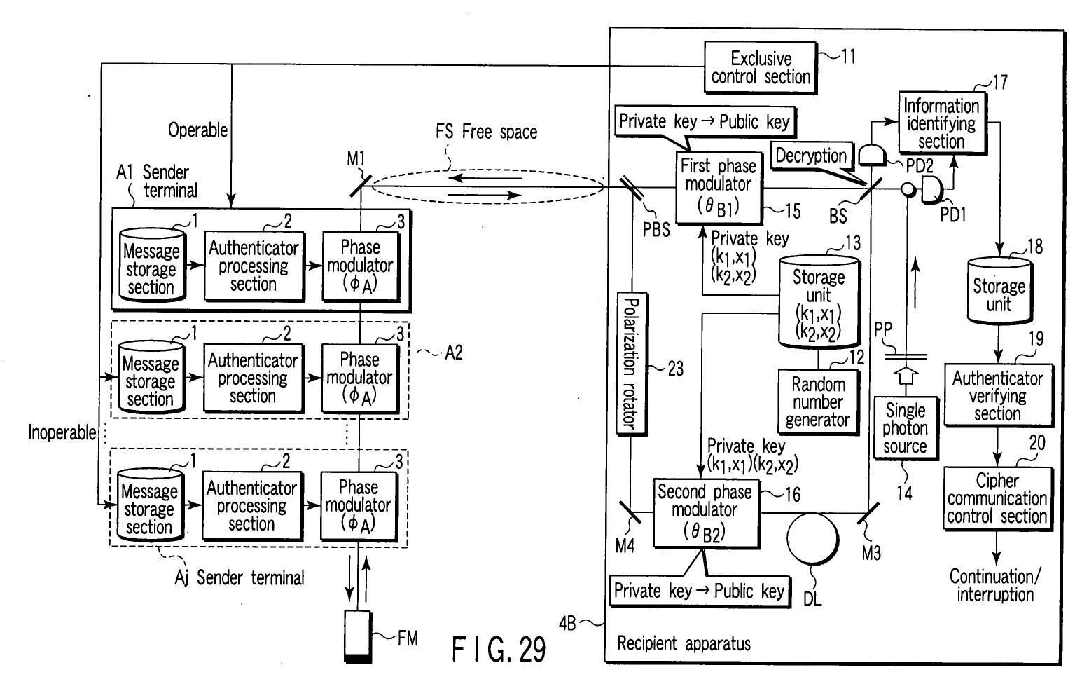

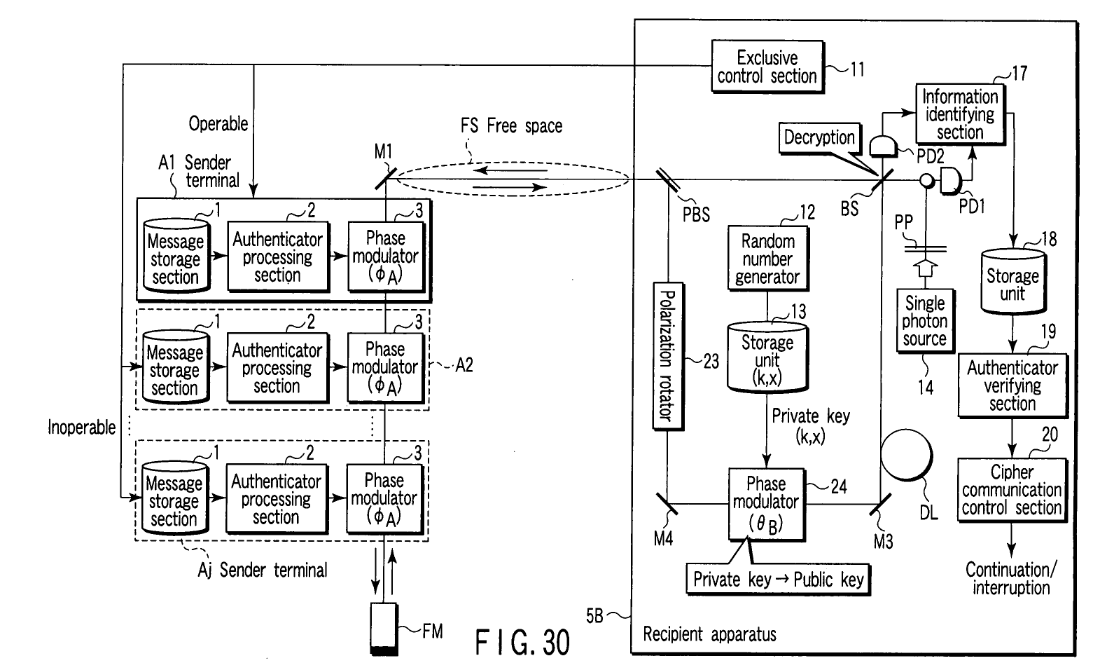

The phase modulator 24 operates at a high speed in synchronization with the time when pulse P1 passes through. The phase modulator 24 changes the phase of the first public quantum state of pulse P1 by the phase delay θ_{B} on the basis of the private keys (k, x). The phase delay θ_{B} is set in the phase modulator 24 as shown in FIG. 23. Thereafter, the phase modulator 24 outputs pulse P1 having the first public key quantum state, the result of changing the phase. The output pulse P1 is input to the beam splitter BS via the third reflecting mirror M3 and delay line DL.

(Pulse P2 in the Second Path)

The recipient apparatus 5B causes the phase modulator 24 to operate at a high speed in synchronization with the time when pulse P2 passes through. According to the private keys (k, x), the recipient apparatus 5B sets the value of a phase delay θ_{B} as shown in FIG. 24 and encodes pulse P2 (ST4). The recipient apparatus 5B outputs the resulting pulse P2 having the second public key quantum state (|x>ₖ). Thereafter, pulse P2 has its polarization components rotated by the polarization rotator 23 by n/2 radians and is reflected by the polarizing beam splitter PBS. The reflected pulse P2 passes through the public quantum channel QC1 and is transmitted to the sender terminals A1 to Aj (ST5).

As described above, in the sender terminal A1, the authenticator processing section 2 obtains an authenticator H(m) from N-bit message information m in the message storage section 1 and generates concatenated data m|H(m) obtained by bit-concatenating the message information m and authenticator H(m).

The sender terminal A1 does not operate the phase modulator 3 when pulse P2 passes through for the first time. Pulse P2 is reflected by the Faraday mirror FM. At this time, the polarization component is rotated by n/2 radians. The sender terminal A1 operates the phase modulator 3 at a high speed in synchronization with the time when the reflected pulse P2 passes through. The phase modulator 3 sets the value of a phase delay φ_{A} as shown in FIG. 25 according to the bit value b to be encoded and encodes pulse P2 (ST6). The phase modulator 3 outputs pulse P2 having the second encrypted text quantum state (|x(+)[m|H(m)]>ₖ), the result of the encoding.

The pulse P2 passes through the public quantum channel QC1 again and reaches the polarizing beam splitter PBS of the recipient apparatus 5B.

Since the polarization components have been changed at the Faraday mirror FM, the pulse P2 passes through the polarizing beam splitter PBS and is input to the beam splitter BS.

(Mixing and Verifying Process of Pulses P1 and P2)

Pulses P1, P2 are mixed with each other at the beam splitter BS. The resulting pulses are output as two quantum states to the first and second photon detectors PD1, PD2.

Hereinafter, as described above, the first and second photon detectors PD1, PD2 detect a single photon. The information identifying section 17 identifies the message information m′ and authenticator a and writes them. The authenticator verifying section 19 performs verification. Then, the cipher communication control section 20 accepts or invalidates the message information m′.

As described above, the fifth embodiment is such that the first phase modulator 15 is eliminated from the fourth embodiment. Even such a configuration produces the same effect as that of the fourth embodiment. In addition, the elimination of the first phase modulator 15 enables the configuration of the fourth embodiment to be simplified.

In all of the above embodiments, optical fiber has been used for the quantum public channels QC1, QC2. The present invention is not limited to the above embodiments. For instance, the embodiments may be so modified that the quantum public channels QC1, QC2 are eliminated and free space FS is used as a channel. Even modifying the embodiment in this way enables the invention to be practiced in the same manner, which produces the same effect.

This invention is not limited to the above embodiments. The present invention may be embodied by modifying the component elements of each embodiment without departing from the spirit or essential character thereof. Furthermore, in the invention, various inventions may be extracted by combining suitably a plurality of component elements disclosed in the embodiments. For example, some components may be removed from all of the component elements constituting the embodiments. In addition, component elements used in two or more embodiments may be combined suitably.

What is claimed is:

1. A public key encryption apparatus comprising:
a device configured to generate a single photon;
a random number generating device configured to generate a random number;
a storage device configured to store the generated random number as a private key;
a device configured to divide the random number of the private key into a basis set identifying value section and a bit value section to allocate quantum states, and encode the random number of the private key as a quantum state of the single photon;
a device configured to transmit the encoded single photon;
a device configured to receive the transmitted single photon;
a device configured to generate message information to be transmitted and an authenticator depending on the message information;
a device configured to encrypt the message information and authenticator into a quantum state of the single photon by bit-inverting the quantum state of the received single photon;
a device configured to transmit the encrypted single photon;
a device configured to receive the transmitted single photon;
a device configured to measure the received single photon on the basis of the private key in the storage device and decrypt the encrypted message information and authenticator according to the result of the measurement;
a device configured to calculate an authenticator from the decrypted message information, compare the calculated authenticator with the encrypted authenticator, and determine whether they coincide with each other; and
a device configured to invalidate the encrypted message information if the result of the measurement has shown that they do not coincide with each other.

2. A public key encryption apparatus comprising:
a single photon generator which generates single photons sequentially;
a random number generator which generates a random number;
a storage medium in which the generated random number is stored;
a first phase modulator which encodes a quantum state by changing the phase of the single photon according to the random number in the storage medium;
a second phase modulator which bit-inverts the encoded single photon, while maintaining the basis set of the quantum state, by changing the phase of the encoded single photon, and which encodes message information and an authenticator as the result of the bit-inversion;
a third phase modulator which, according to the random number in the storage medium, changes the phase of the single photon encoded by the second phase modulator; and
a device which is configured to have a photon detector on each of the transmission optical axis and reflection optical axis of a beam splitter and detect the phase of the single photon obtained by the third phase modulator.

3. A public key encryption apparatus comprising:
a single photon generator which generates single photons sequentially;
a random number generator which generates a random number;
a storage medium in which the generated random number is stored;
a first polarizer which encodes a quantum state by changing the polarization component of the single photon according to the random numbers in the storage medium;
a second polarizer which bit-inverts the encoded single photon, while maintaining the basis set of the quantum state, by changing the polarization component of the encoded single photon, and which encodes message information and an authenticator as the result of the bit-inversion;
a third polarizer which, according to the random number in the storage medium, changes the polarization component of the single photon encoded by the second polarizer; and
a device which is configured to have a photon detector on each of the transmission optical axis and reflection optical axis of a polarizing beam splitter and detect the polarization component obtained by the third polarizer.

4. A public key encryption apparatus comprising:
a device configured to store a private key as classic information (x, k);
a device configured to encode the stored classic information (x, k) into a quantum state and output a public key as quantum information |x>ₖ, the result of encoding;
a device configured to encode previously stored message information and an authenticator which depends on the message and whose bit position relationship is unobvious into a quantum state of the public key when receiving the public key and output an encrypted text, the result of encoding;
a device configured to measure the quantum state of the encrypted text on the basis of the public key k when receiving the encrypted text and decrypt the encrypted text, the result of the measurement;
a device configured to verify the consistency between the message information and authenticator obtained through the decryption; and
a device configured to detect the interception or falsification of the public key or the encrypted text when the consistency has not been verified.

5. A public key encryption apparatus comprising:
a quantum information creating device configured to perform the process (b, k) [symbol] |b>ₖ of creating quantum information |b>ₖ from classic information (b, k) composed of the basis set identifying information k and bit value b, if basis set identifying information on a quantum state is k and a bit value in the basis set identified by the basis set identifying information is b; and
a quantum information output device configured to output the quantum information |b>ₖ,
wherein the output quantum information |b>ₖ is guaranteed to be safe from interception or falsification on the basis of the creating process being equivalent to one-way function mapping with trapdoor information k and of the uncertainty principle in the quantum theory.

6. A public key encryption apparatus comprising a recipient apparatus and a sender apparatus,
the recipient apparatus including
a public key storage device configured to store a public key composed of basis set identifying random number information and phase modulation random number information,
a photon generating device configured to generate single photons sequentially,
a photon dividing device configured to divide the single photon into two quantum states and output a first quantum state and a second quantum state, the result of the division,
a first phase modulation device configured to change the phase of the first quantum state on the basis of the private key in the private key storage device and output a public key quantum state, the result of changing the phase, toward the sender apparatus,
a second phase modulation device configured to change the phase of an encrypted text quantum state on the basis of the private key in the private key storage device so as to offset a variation in the phase caused by the first phase modulation device from the encrypted text quantum state, when receiving from the sender apparatus the encrypted text quantum state obtained by inverting the phase of the public key quantum state according to each bit in message information and an authenticator, and obtain a plain text quantum state, the result of the changing the phase,
a photon phase detecting device configured to detect the phase of a single photon from the plain text quantum state and the second quantum state and obtain each bit according to the result of the detection,
a detection result storage device configured to store the message information and authenticator composed of each bit,
a verifying device configured to verify whether the message information and authenticator in the detection result storage device are consistent with each other, and
a message invalidating device configured to invalidate the message information in the detection result storage device if the result of the verification has shown that the message information and authenticator are inconsistent with each other, and
the sender apparatus including
a message storage device configured to store message information,
an authenticator processing device configured to generate an authenticator from the message information in the message storage device and concatenate the authenticator with the message information, and
a third phase modulation device configured to invert the phase of the public key quantum state, while maintaining the basis set of the public key quantum state output from the recipient apparatus, on the basis of each bit in the concatenated message information and authenticator, and output the encrypted text quantum state, the result of inverting the phase, toward the recipient apparatus.

7. A public key encryption apparatus comprising a recipient apparatus and a sender apparatus,
the recipient apparatus including
a public key storage device configured to store a public key composed of basis set identifying random number information and phase modulation random number information,
a photon generating device configured to generate single photons sequentially,
a phase modulation device configured to change the phase of the single photon on the basis of the private key in the private key storage device and output a public key single photon, the result of changing the phase,
a photon dividing device configured to divide the public key single photon into two quantum states and output a first public key quantum state and a second public key quantum state, the result of the division,
a photon phase detecting device configured to detect the phase of a single photon from the encrypted text quantum state and the second public key quantum state when receiving from the encrypted test state obtained by inverting the phase of the first public key quantum state according to each bit in message information and an authenticator, and obtain each bit according to the result of the detection,
a detection result storage device configured to store the message information and authenticator composed of each bit,
a verifying device configured to verify whether the message information and authenticator in the detection result storage device are consistent with each other, and
a message invalidating device configured to invalidate the message information in the detection result storage device if the result of the verification has shown that the message information and authenticator are inconsistent with each other, and
the sender apparatus including
a message storage device configured to store message information,
an authenticator processing device configured to generate an authenticator from the message information in the message storage device and concatenate the authenticator with the message information, and
a third phase modulation device configured to invert the phase of the first public key quantum state, while maintaining the basis set of the first public key quantum state output from the recipient apparatus, on the basis of each bit in the concatenated message information and authenticator, and output the encrypted text quantum state, the result of inverting the phase, toward the recipient apparatus.

8. A public key encryption apparatus comprising a recipient apparatus and a sender apparatus,
the recipient apparatus including
a public key storage device configured to store a public key composed of basis set identifying random number information and random number polarization information,
a photon generating device configured to generate single photons sequentially,
a first polarizing device configured to change the polarization component of the single photon on the basis of the private key in the private key storage device and output a public key quantum state, the result of the changing, toward the sender apparatus,
a second polarizing device configured to change the polarization component of the encrypted text quantum state on the basis of the private key in the private key storage device so as to offset a variation in the polarization component caused by the first polarizing device from the encrypted text quantum state, when receiving from the sender apparatus the encrypted text quantum state obtained by rotating the polarization component of the public key quantum state by n/2 radians according to each bit in message information and an authenticator, and obtain a plain text quantum state, the result of the changing,
a photon phase detecting device configured to detect the polarization component of a single photon from the plain text quantum state and obtain each bit according to the result of the detection,
a detection result storage device configured to store the message information and authenticator composed of each bit,
a verifying device configured to verify whether the message information and authenticator in the detection result storage device are consistent with each other, and
a message invalidating device configured to invalidate the message information in the detection result storage device if the result of the verification has shown that the message information and authenticator are inconsistent with each other, and
the sender apparatus including
a message storage device configured to store message information,
an authenticator processing device configured to generate an authenticator from the message information in the message storage device and concatenate the authenticator with the message information, and
a third polarizing device configured to rotate the polarization component of the public key quantum state by n/2 radians, while maintaining the basis set of the public key quantum state output from the recipient apparatus, on the basis of each bit in the concatenated message information and authenticator, and output an encrypted text quantum state, the result of the rotation, toward the recipient apparatus.

9. A public key encryption apparatus comprising a recipient apparatus, a sender apparatus, and a Faraday mirror,
the recipient apparatus including
a public key storage device configured to store a public key composed of basis set identifying random number information and phase modulation random number information,
a photon generating device configured to generate single photons sequentially,
a photon dividing device configured to divide the single photon into two quantum states and output a first quantum state and a second quantum state, the result of the division,
a first phase modulation device having the function of changing the phase of the first quantum state on the basis of the private key in the private key storage device and outputting a first public key quantum state, the result of changing the phase, toward the sender apparatus and the function of changing the phase of an input second encrypted text quantum state on the basis of the private key in the private key storage device so as to offset a variation in the phase caused by the private key from the second encrypted text quantum state and outputting a second plain text quantum state, the result of changing the phase,
a polarizing beam splitter having the function of causing the output first public key quantum state to pass through toward the sender apparatus, the function of receiving the first public key quantum state obtained by rotating the polarization component of the first public key quantum state through n/2 radians by the Faraday mirror and then reflecting the first public key quantum state, the function of reflecting an input second public key quantum state toward the sender apparatus, and the function of receiving from the sender apparatus a second encrypted text quantum state obtained by rotating the polarization component of the second public key quantum state through n/2 radians by the Faraday mirror and inverting the phase of the second public key quantum state according to each bit in message information and an authenticator and of causing the second encrypted text quantum state to pass through toward the first phase modulation device,
a polarization rotating device having the function of rotating the polarization component of the first public key quantum state reflected by the polarizing beam splitter by n/2 radians and outputting the result and the function of rotating the polarization component of the input second public key quantum state by n/2 radians and outputting the result toward the polarizing beam splitter,
a second phase modulation device having the function of changing the phase of the first public key quantum state on the basis of the private key in the private key storage device so as to offset a variation in the phase caused by the first phase modulation device from the first public key quantum state output from the polarization rotating device and outputting a first quantum state, the result of changing the phase, and the function of changing the phase of the second quantum state on the basis of the private key in the private key storage device and outputting a second public key quantum state, the result of changing the phase, to the polarization rotating device,
a photon phase detecting device configured to detect the phase of a single photon from the first quantum state and the second plain text quantum state output from the respective phase modulation devices and obtain each bit according to the result of the detection,
a detection result storage device configured to store the message information and authenticator composed of each bit,
a verifying device configured to verify whether the message information and authenticator in the detection result storage device are consistent with each other, and
a message invalidating device configured to invalidate the message information in the detection result storage device if the result of the verification has shown that the message information and authenticator are inconsistent with each other, and
the sender apparatus including
a message storage device configured to store message information,
an authenticator processing device configured to generate an authenticator from the message information in the message storage device and concatenate the authenticator with the message information, and
a third phase modulation device configured to invert the phase of the second public key quantum state, while maintaining the basis set of the second public key quantum state, on the basis of each bit in the concatenated message information and authenticator, when receiving the second public key quantum state which is output from the recipient apparatus and whose polarization component is rotated through n/2 radians by the Faraday mirror, and output a second encrypted text quantum state, the result of inverting the phase, toward the recipient apparatus.

10. A public key encryption apparatus comprising a recipient apparatus, a sender apparatus, and a Faraday mirror,
the recipient apparatus including
a public key storage device configured to store a public key composed of basis set identifying random number information and phase modulation random number information,
a photon generating device configured to generate single photons sequentially,
a photon dividing device configured to divide the single photon into two quantum states and output a first quantum state and a second quantum state, the result of the division,
a polarizing beam splitter having the function of causing the output first quantum state to pass through toward the sender apparatus, the function of receiving the first quantum state obtained by rotating the polarization component of the first quantum state through n/2 radians by the Faraday mirror and then reflecting the first quantum state, the function of reflecting an input second public key quantum state toward the sender apparatus, and the function of receiving from the sender apparatus a second encrypted text quantum state obtained by rotating the polarization component of the second public key quantum state through n/2 radians by the Faraday mirror and inverting the phase of the second public key quantum state according to each bit in message information and an authenticator and of causing the second encrypted text quantum state to pass through,
a polarization rotating device having the function of rotating the polarization component of the first quantum state reflected by the polarizing beam splitter by n/2 radians and outputting the result and the function of rotating the polarization component of the input second public key quantum state by n/2 radians and outputting the result toward the polarizing beam splitter,
a phase modulation device having the function of changing the phase of the first quantum state output from the polarization rotating device on the basis of the private key in the private key storage device and outputting a first public key quantum state, the result of changing the phase, and the function of changing the phase of the second quantum state on the basis of the private key in the private key storage device and outputting a second public key quantum state, the result of changing the phase, to the polarization rotating device,
a photon phase detecting device configured to detect the phase of a single photon from the first public key quantum state and the second encrypted text quantum state and obtain each bit according to the result of the detection,
a detection result storage device configured to store the message information and authenticator composed of each bit,
a verifying device configured to verify whether the message information and authenticator in the detection result storage device are consistent with each other, and
a message invalidating device configured to invalidate the message information in the detection result storage device if the result of the verification has shown that the message information and authenticator are inconsistent with each other, and
the sender apparatus including
a message storage device configured to store message information,
an authenticator processing device configured to generate an authenticator from the message information in the message storage device and concatenate the authenticator with the message information, and
a third phase modulation device having the function of inverting the phase of the first quantum state, while maintaining the basis set of the first quantum state output from the recipient apparatus, on the basis of each bit in the concatenated message information and authenticator and outputting a first plain text quantum state, the result of inverting the phase, and the function of inverting the phase of the second public key quantum state, while maintaining the basis set of the second public key quantum state output from the recipient apparatus, on the basis of each bit in the concatenated message information and authenticator, and outputting a second encrypted text quantum state, the result of inverting the phase, toward the recipient apparatus.
